(19) United States
(12) Patent Application Publication
(10) Pub. No.: US 2014/0349696 A1
(43) Pub. Date: Nov. 27, 2014

(54) SUPPORTING ANTENNA ASSEMBLY CONFIGURATION NETWORK INFRASTRUCTURE

(71) Applicant: Elwha LLC, a limited liability corporation of the State of Delaware, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Douglas O. Reudink, Port Townsend, WA (US); Clarence T. Tegreene, Mercer Island, WA (US)

(21) Appl. No.: 13/936,921

(22) Filed: Jul. 8, 2013

Related U.S. Application Data
(63) Continuation-in-part of application No. 13/904,970, filed on May 29, 2013.
Application No. 13/904,970 is a continuation of application No. 13/902,585, filed on May 24, 2013.
Application No. 13/902,585 is a continuation-in-part of application No. 13/842,040, filed on Mar. 15, 2013.

(51) Int. Cl. H04W 24/02

(52) U.S. Cl. CPC H04W 24/02
USPC 455/517

(57) ABSTRACT

Disclosed herein are example embodiments for supporting network infrastructure for sharing antenna assembly configuration parameters. For certain example embodiments, at least one device, such as a portable wireless node: (i) may present at least one interface to facilitate implementation of an antenna assembly configuration parameter framework; or (ii) may communicate with at least one remote node to share one or more antenna assembly configuration parameters that are associated with at least one orientation position of at least one portable wireless node. However, claimed subject matter is not limited to any particular described embodiments, implementations, examples, or so forth.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

(1) For purposes of the USPTO extra-statutory requirements, the present application constitutes a continuation-in-part of U.S. patent application Ser. No. 13/842,040, entitled “Frequency Accommodation”, naming Roderick A. Hyde, Royce A. Levien, Richard T. Lord, Robert W. Lord, Mark A. Malamud, Douglas O. Reudink, and Clarence T. Tegreene as inventors, filed 15 Mar. 2013 (with Atty. Docket No. SE1-0855-US), which is currently co-pending or is an application of which a currently co-pending application is entitled to the benefit of the filing date.

(2) For purposes of the USPTO extra-statutory requirements, the present application constitutes a continuation-in-part of U.S. patent application Ser. No. 13/902,585, entitled “Facilitating Wireless Communication in Conjunction with Orientation Position”, naming Roderick A. Hyde, Royce A. Levien, Richard T. Lord, Robert W. Lord, Mark A. Malamud, Douglas O. Reudink, and Clarence T. Tegreene as inventors, filed 24 May 2013 (with Atty. Docket No. SE1-0856-US), which is currently co-pending or is an application of which a currently co-pending application is entitled to the benefit of the filing date.

(3) For purposes of the USPTO extra-statutory requirements, the present application constitutes a continuation-in-part of U.S. patent application Ser. No. 13/904,970, entitled “Facilitating Wireless Communication in Conjunction with Orientation Position”, naming Roderick A. Hyde, Royce A. Levien, Richard T. Lord, Robert W. Lord, Mark A. Malamud, Douglas O. Reudink, and Clarence T. Tegreene as inventors, filed 29 May 2013 (with Atty. Docket No. SE1-0857-US), which is currently co-pending or is an application of which a currently co-pending application is entitled to the benefit of the filing date.

### RELATED APPLICATIONS

(1) U.S. patent application Ser. No. 13/317,338, entitled “Surface Scattering Antennas”, naming Adam Bily, Anna K. Boardman, Russell J. Hannigan, John Hunt, Nathan Kundtz, David R. Nash, Ryan Allan Stevenson, and Philip A. Sullivan as inventors, filed 14 Oct. 2011 (with Docket No. 0209-011-001-000000), is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BRIEF DESCRIPTION OF THE FIGURES

FIG. 1 is a block diagram indicative of a spatial relationship or interconnectedness of drawing sheets that respectively correspond to FIGS. 1A-1L, which together depict at least an example enviro-system related to certain example embodiments.

FIG. 1A is a schematic diagram of example wireless nodes in accordance with certain example embodiments.

FIGS. 1B-1L are individual schematic diagrams that may be combined to form a joint schematic diagram illustrating example implementations for accommodating one or more different frequencies in a wireless environment in accordance with certain example embodiments.

FIG. 2 is a schematic diagram of an example portable wireless node including one or more example components in accordance with certain example embodiments.

FIG. 3 is a schematic diagram of an example fixed node, such as a fixed wireless node or a fixed wired node, including one or more example components in accordance with certain example embodiments.

FIG. 4A is a schematic diagram that includes at least one example device, such as a portable wireless node, that is capable of handling scenarios for supporting antenna assembly configuration network infrastructure in accordance with certain example embodiments.

FIGS. 4B-4D are schematic diagrams that include at least one example device and that depict example scenarios for supporting antenna assembly configuration network infrastructure in accordance with certain example embodiments.

FIG. 5 is a flow diagram illustrating an example method for at least one device with regard to supporting antenna assembly configuration network infrastructure in accordance with certain example embodiments.

FIGS. 6A-6F depict example additions or alternatives for a flow diagram of FIG. 5 in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

For certain example embodiments, one or more wireless communication parameters may be adopted by a mobile device based at least partially on a physical state of a mobile device to strengthen, enhance, improve, or a combination thereof, etc. a communication channel between a mobile device and another wireless device, such as a base station. Additionally or alternatively, a physical state of (e.g., a location of or an orientation of) a mobile device may be altered to strengthen, enhance, improve, or a combination thereof, etc. a communication channel between a mobile device and an another device, such as a base station (e.g., orientation of at least one communicating device may be altered to strengthen, enhance, improve, or a combination thereof, etc. a communication channel between/among one or more wireless devices).

For certain example embodiments, a physical state of a mobile device may include a spatial location of the mobile device or an orientation of the mobile device. For certain example implementations, a spatial location (e.g., which may be merged with or incorporated into or linked to 3-D mapping data, including those of buildings) may be represented with a geographical position of a mobile device (e.g., with regard to a point on the earth) or an elevation of a mobile device (e.g., with regard to a height above the earth). For certain example implementations, an orientation may be represented with (1) Euler angles or rotations or (2) pitch, roll, or yaw in 3-D Euclidean space.

For certain example embodiments, one or more wireless communication parameters, such as one or more antenna assembly configuration parameters, may include, but are not limited to any one or more of the following. First, an antenna element set may be selected from among multiple antenna elements of an antenna array. Second, a particular phase or delay may be applied to each antenna element of a selected set of antenna elements. Third, a particular power may be applied to each antenna element of a selected set of antenna elements. Fourth, a phased array antenna (e.g., which may be formed from multiple antenna elements comprising or including a single dipole) may include multiple antenna elements that are driven with particular signal values. For instance, different elements (e.g., if an element is covered/blocked), phases/delays, power, or a combination thereof, etc. may be applied to input/output connections of a phased array antenna (e.g., to establish or form a beam). Antennas, including but not limited to antenna arrays or phased arrays, may comprise or include or be formed or constructed using meta-materials. Fifth, a frequency of wireless signal(s) coupled to or from an antenna may be adjusted. Sixth, a frequency band or a wireless communication standard that is being employed may be altered, including but not limited to using a different antenna to support a different frequency band or wireless communication standard.

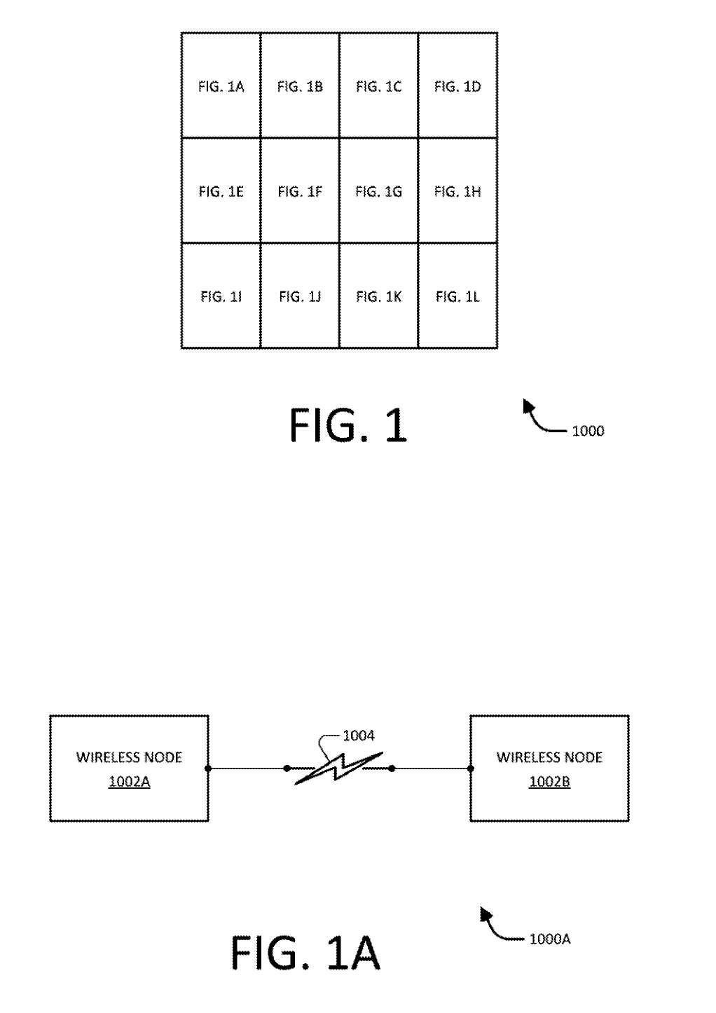

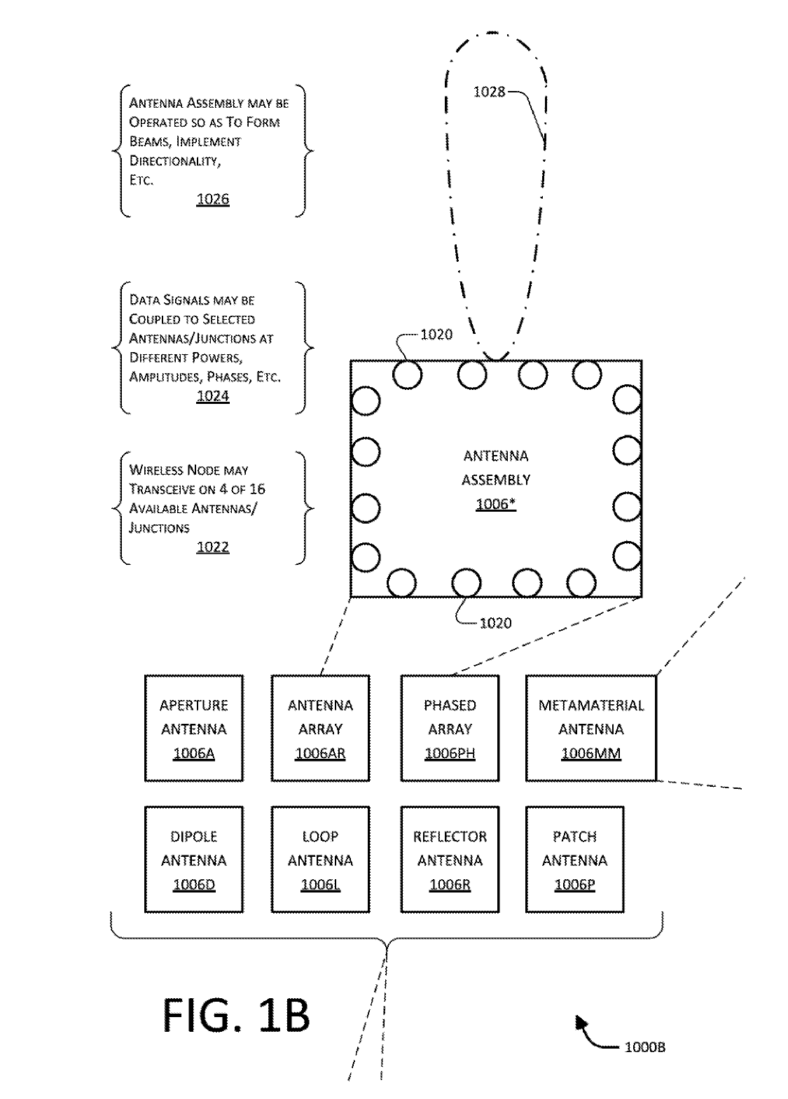

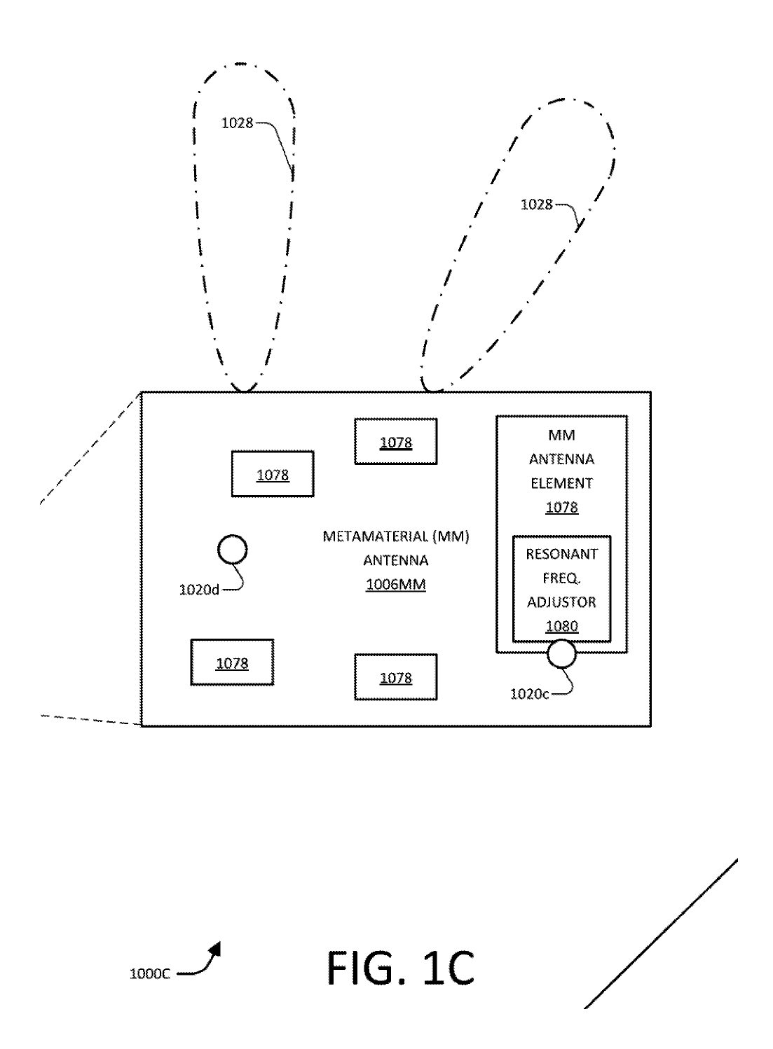

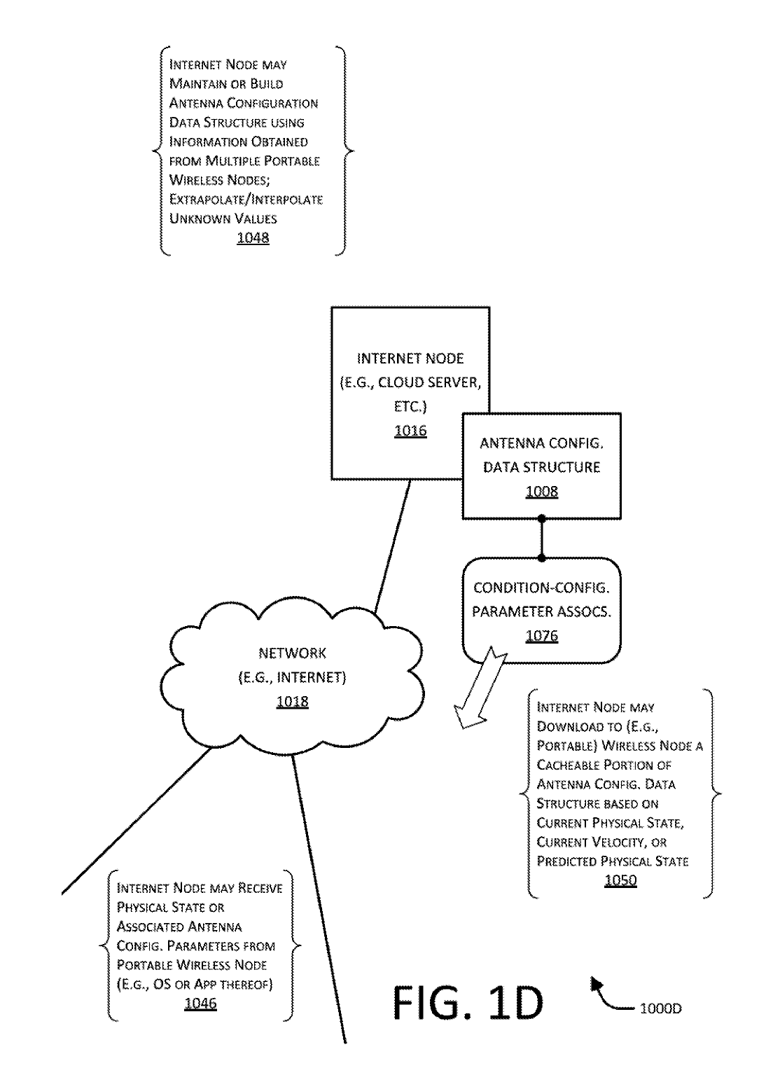

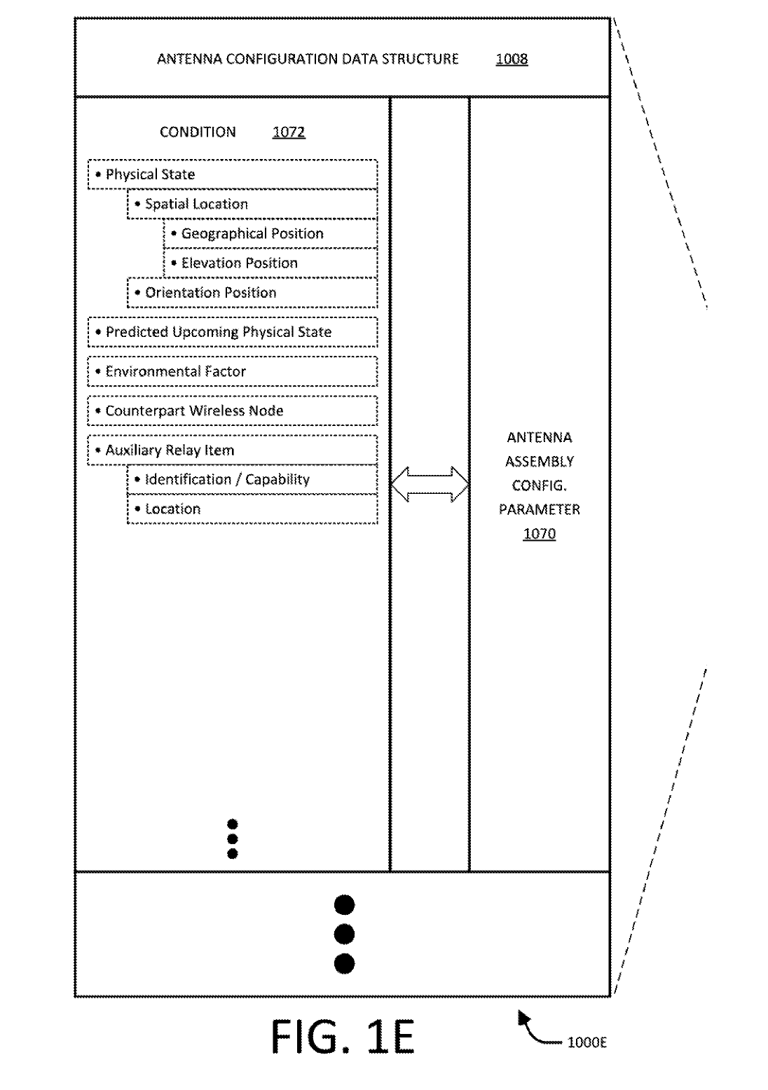

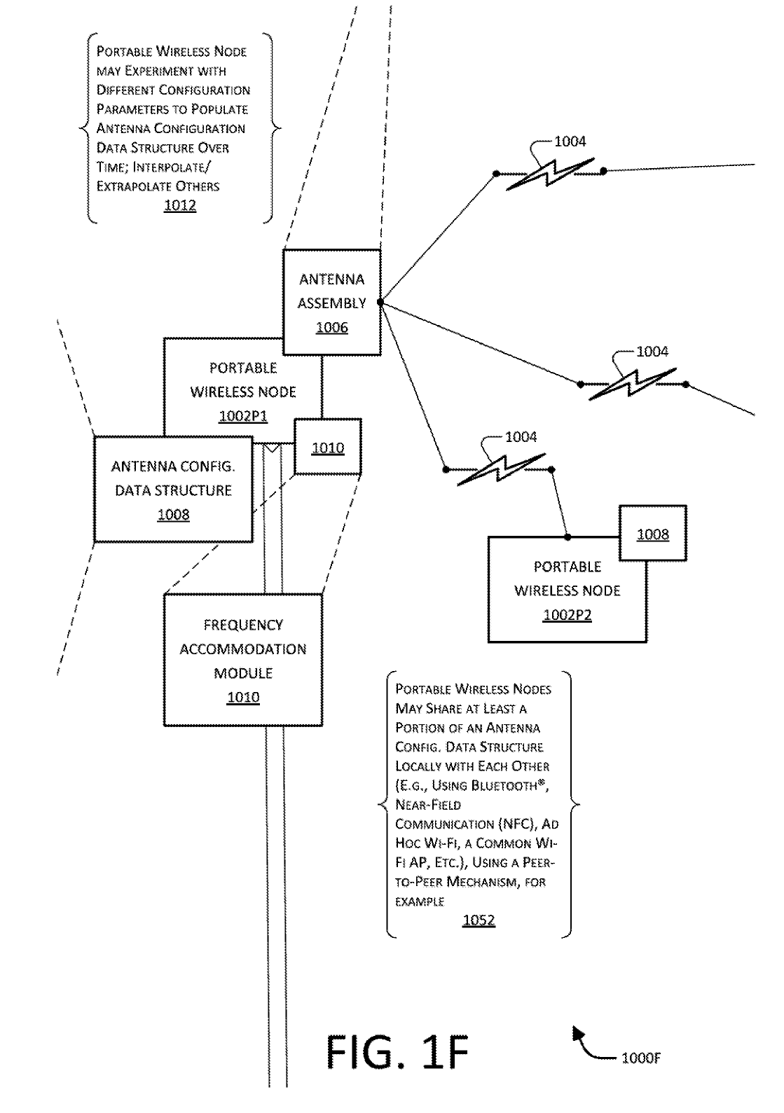

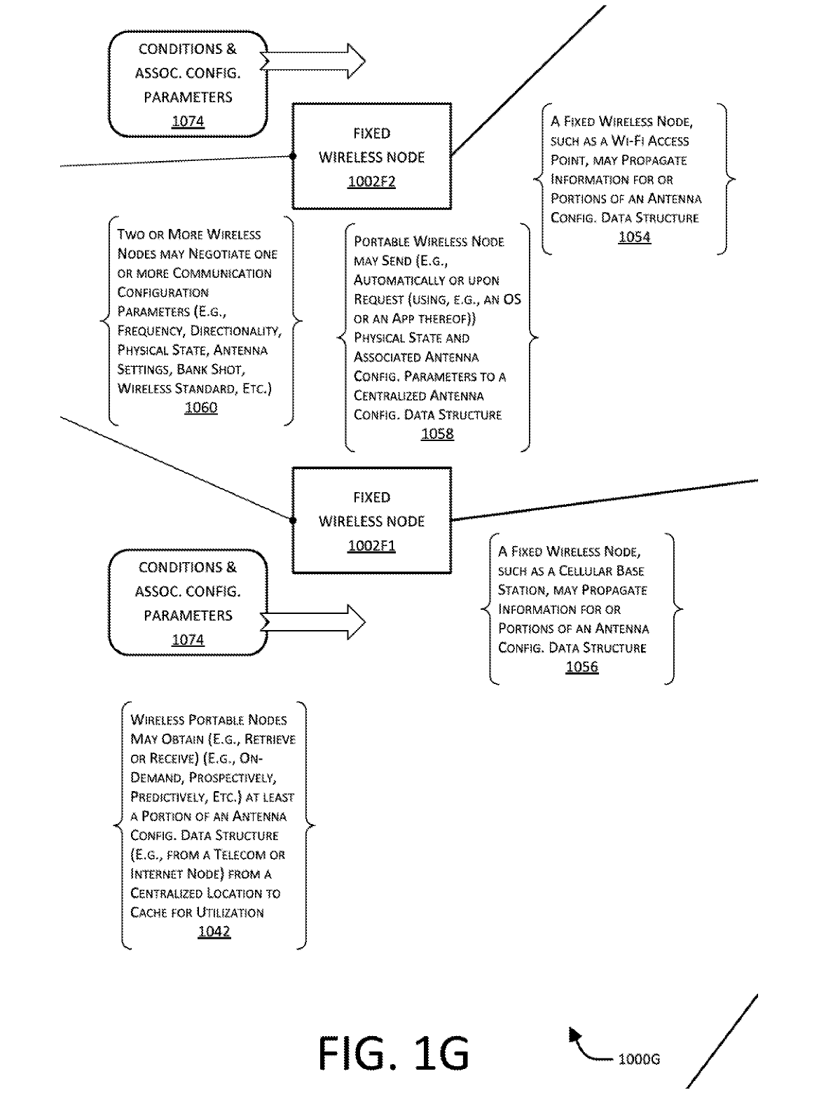

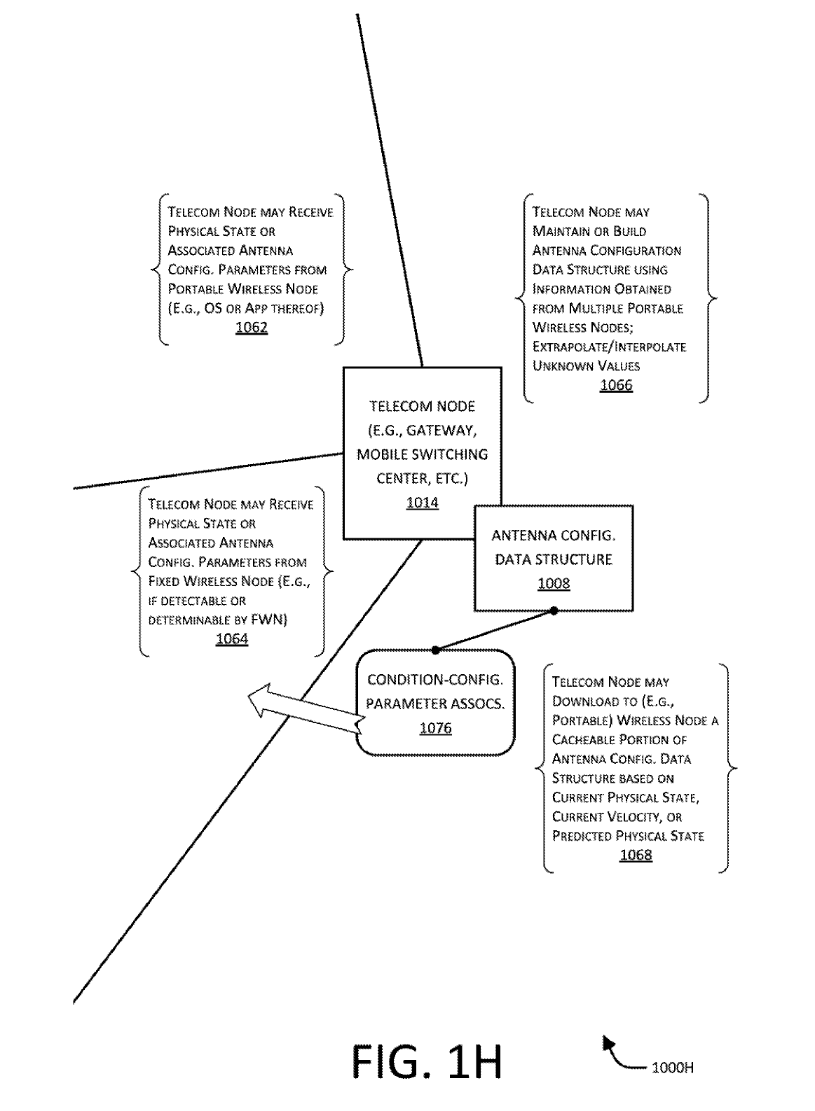

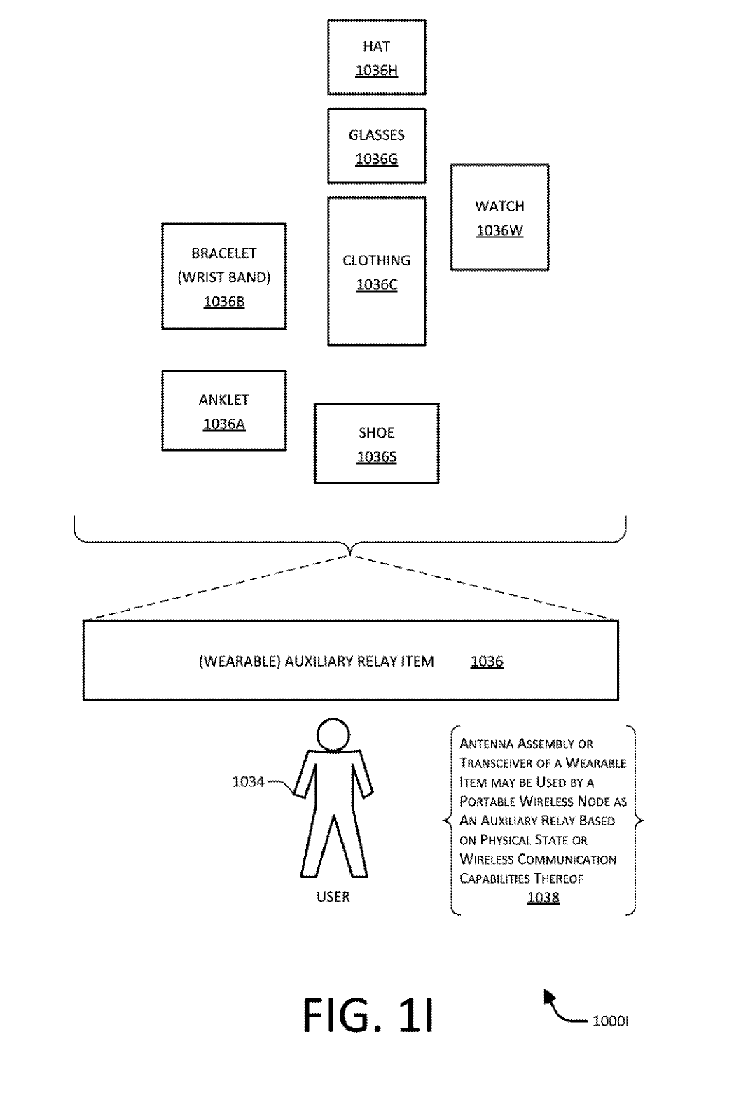

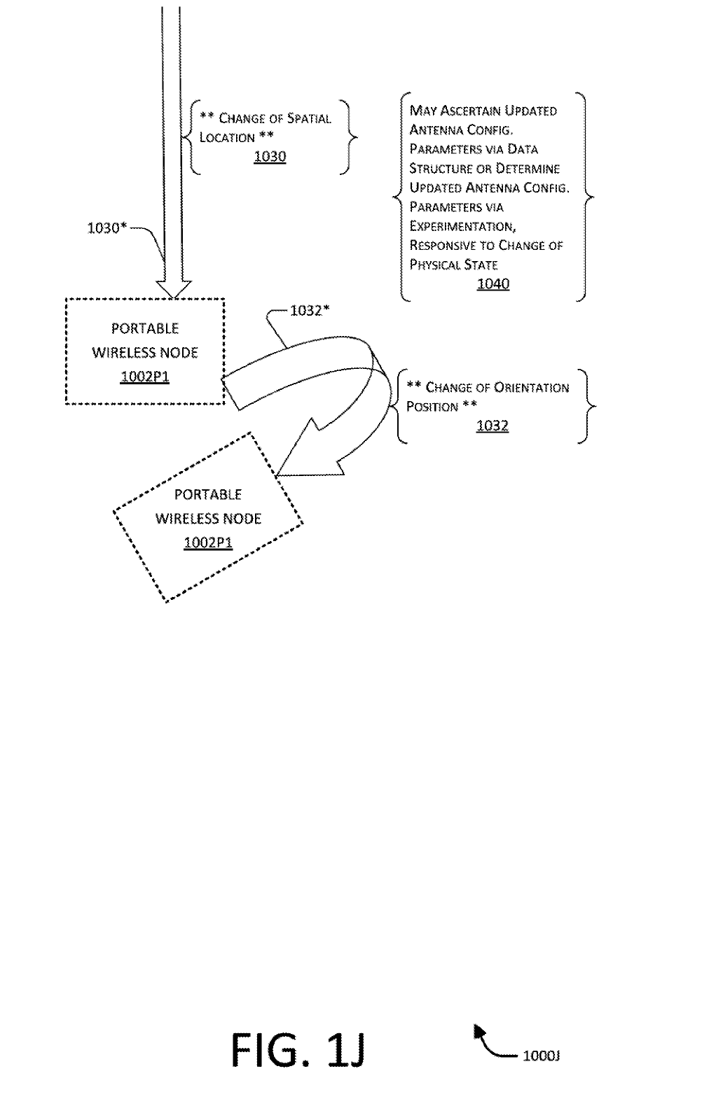

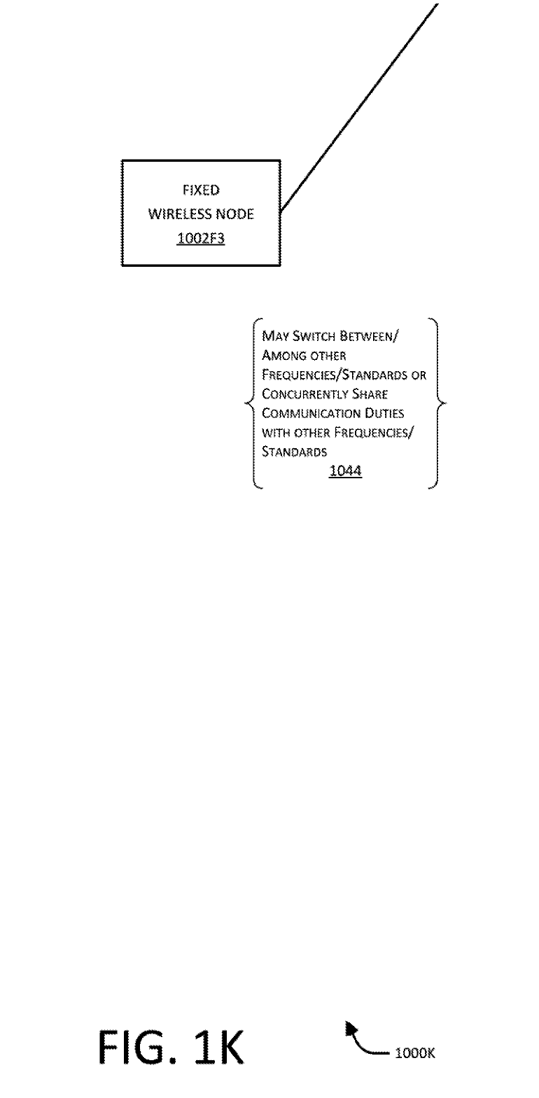

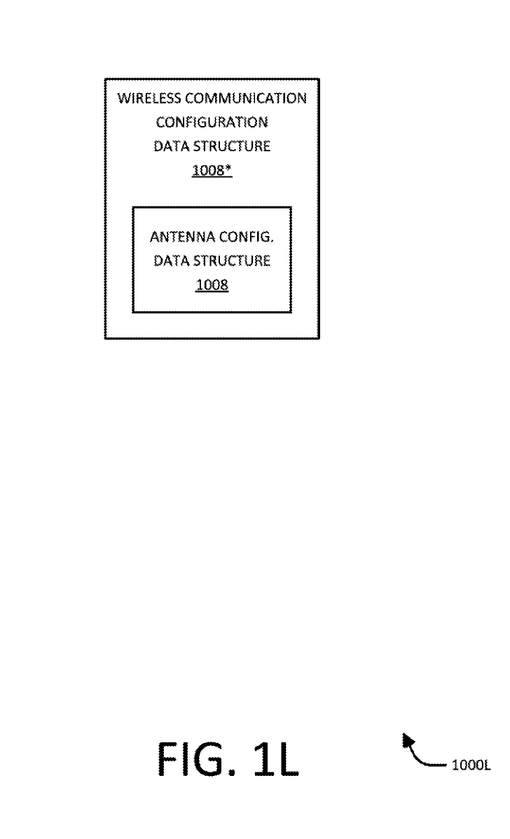

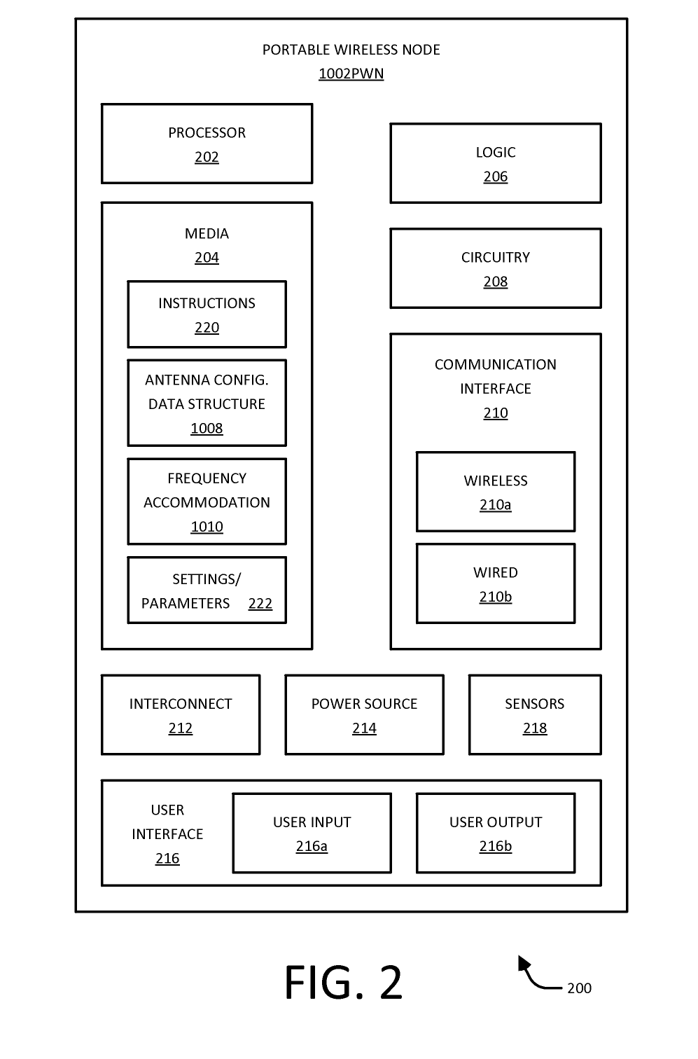

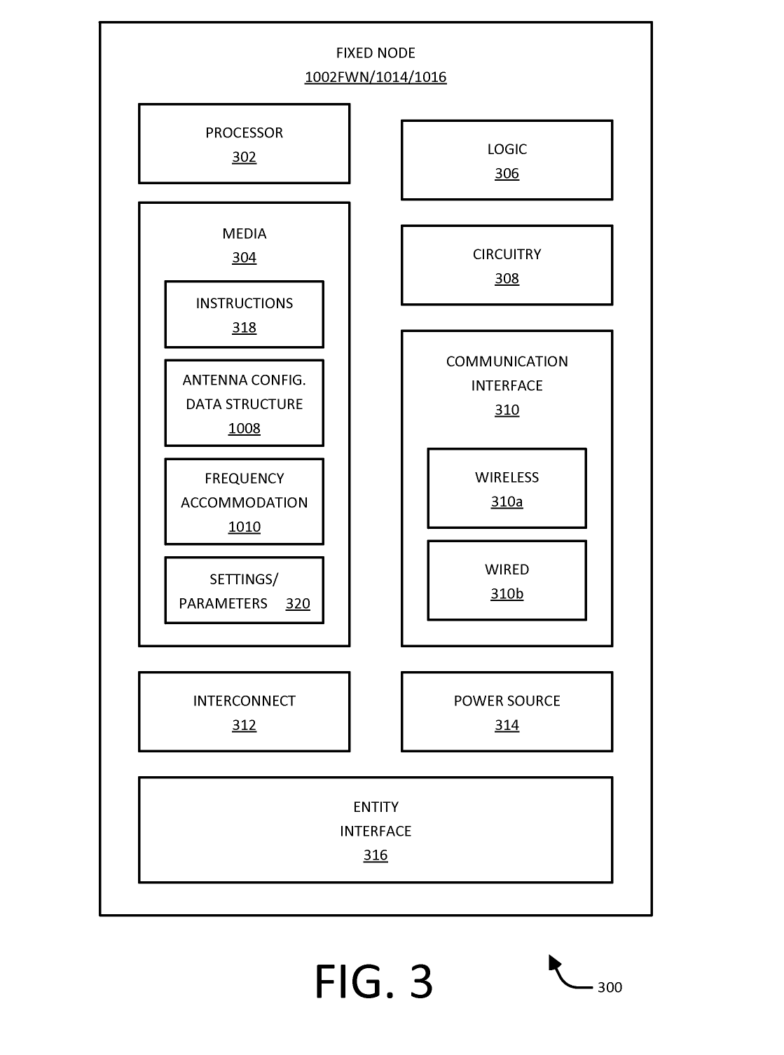

APPLICANT HEREBY INCORPORATES BY REFERENCE HEREIN DESCRIPTION OF AND TEXT ASSOCIATED WITH FIGS. 1-3 (E.G., FIGS. 1, 1A, 1B, 1C, 1D, 1E, 1F, 1G, 1H, 11, 1J, 1K, 1L, 2, AND 3), INCLUDING BUT NOT LIMITED TO PARAGRAPHS [0017]-[0092] INCLUSIVE IN THEIR ENTIRETY, AT LEAST TO THE EXTENT SUCH SUBJECT MATTER IS NOT INCONSISTENT HEREWITH, OF U.S. patent application Ser. No. 13/842,040, entitled “Frequency Accommodation”, naming Roderick A. Hyde et al. as inventors, filed 15 Mar. 2013 (with Atty. Docket No. SE1-0855-US).

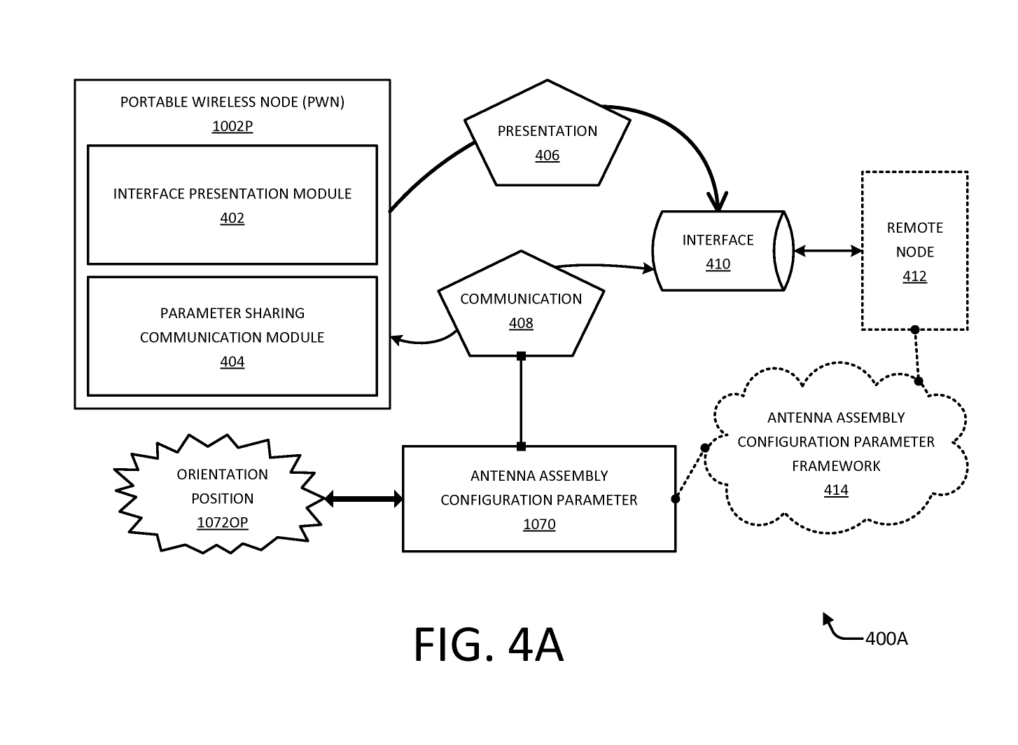

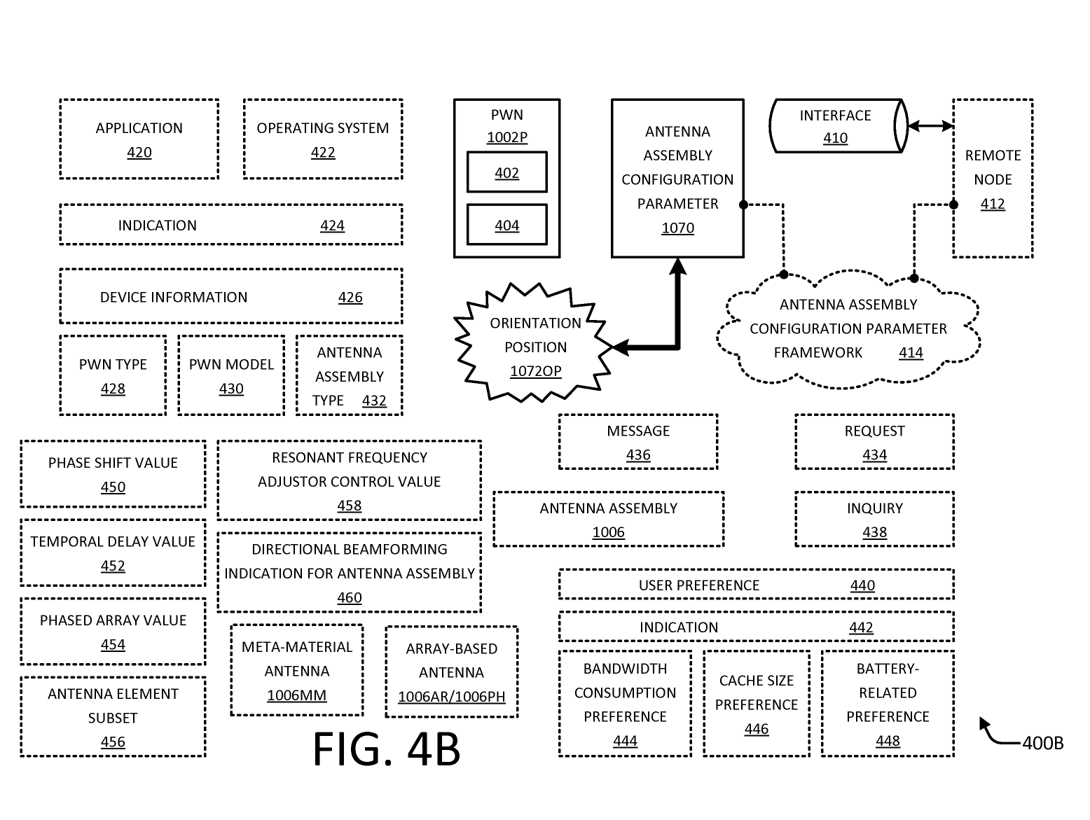

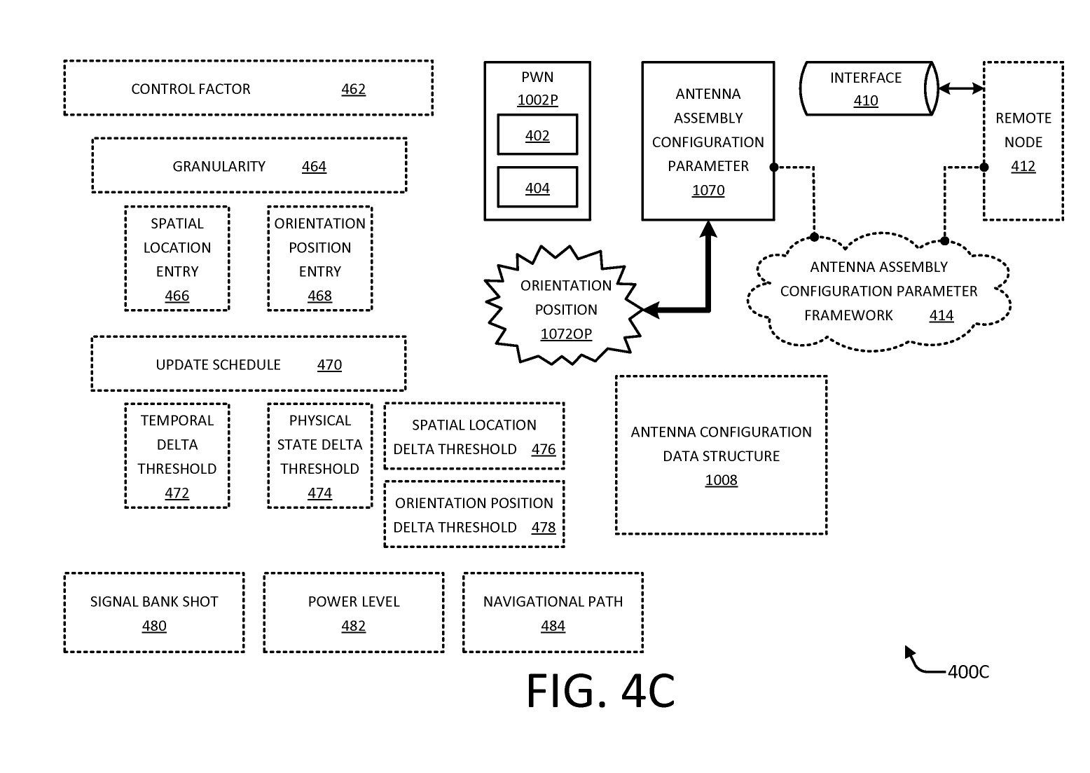

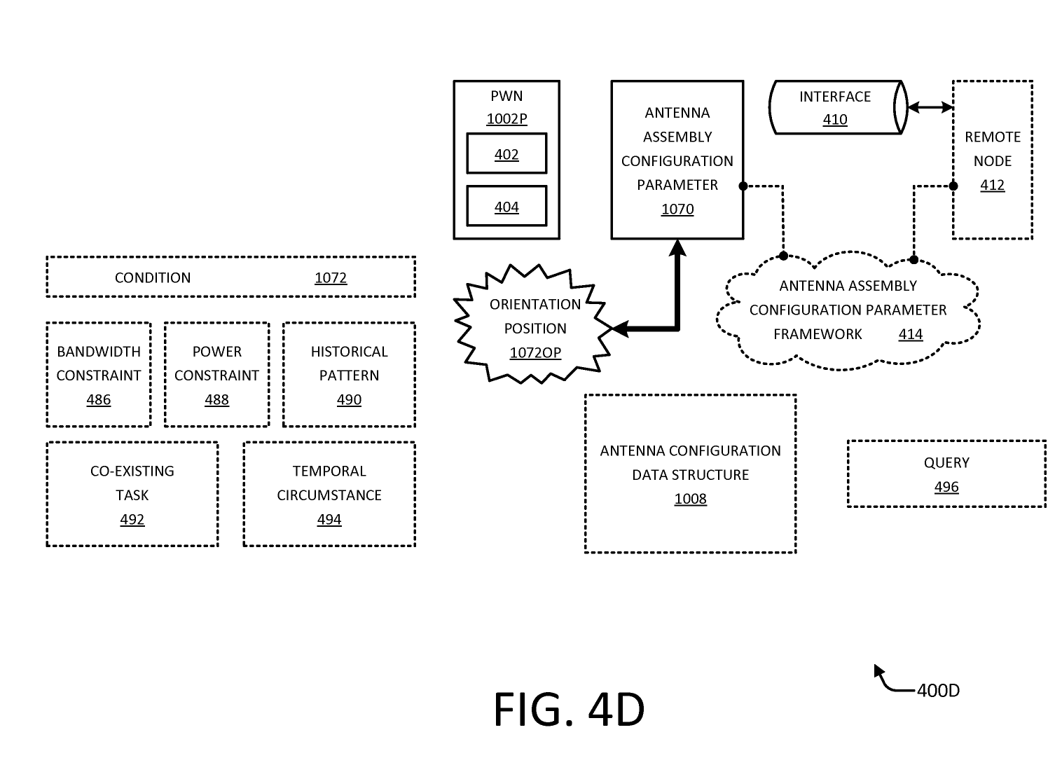

FIG. 4A is a schematic diagram 400A that includes at least one example device, such as a portable wireless node, that is capable of handling scenarios for supporting antenna assembly configuration network infrastructure in accordance with certain example embodiments. As shown in FIG. 4A, by way of example but not limitation, schematic diagram 400A depicts at least one device that may include at least one interface presentation module 402 or at least one parameter sharing communication module 404. Additionally or alternatively, schematic diagram 400A may include, by way of example but not limitation, at least one presentation 406, at least one communication 408, at least one interface 410, at least one remote node 412, at least one antenna assembly configuration parameter framework 414, at least one antenna assembly configuration parameter 1070, or at least one orientation position 1072OP. More specifically, schematic diagram 400A may depict at least one device that includes or comprises at least one portable wireless node (PWN) 1002P. By way of example but not limitation, an interface presentation module 402 or a parameter sharing communication module 404 may include or comprise or be realized with at least one processor that executes instructions (e.g., sequentially, in parallel, at least partially overlapping in a time-multiplexed fashion, at least partially across multiple cores, or a combination thereof, etc.) as at least one special-purpose computing component, or otherwise as described herein. However, claimed subject matter is not limited to any particular described embodiments, implementations, examples, etc.

For certain example embodiments, an interface presentation module 402 or a parameter sharing communication module 404 may be implemented separately or at least partially jointly or in combination with or by at least one portable wireless node 1002P. For certain example implementations, an interface presentation module 402 may be configured to present (e.g., via at least one presentation 406) at least one interface 410 to facilitate implementation of an antenna assembly configuration parameter framework 414. For certain example implementations, a parameter sharing communication module 404 may be configured to communicate (e.g., via at least one communication 408) with at least one remote node 412 to share one or more antenna assembly configuration parameters 1070 that are associated with at least one orientation position 1072OP of at least one portable wireless node (e.g., which may be a same or a different portable wireless node 1002P as performs presentation 406 or communication 408).

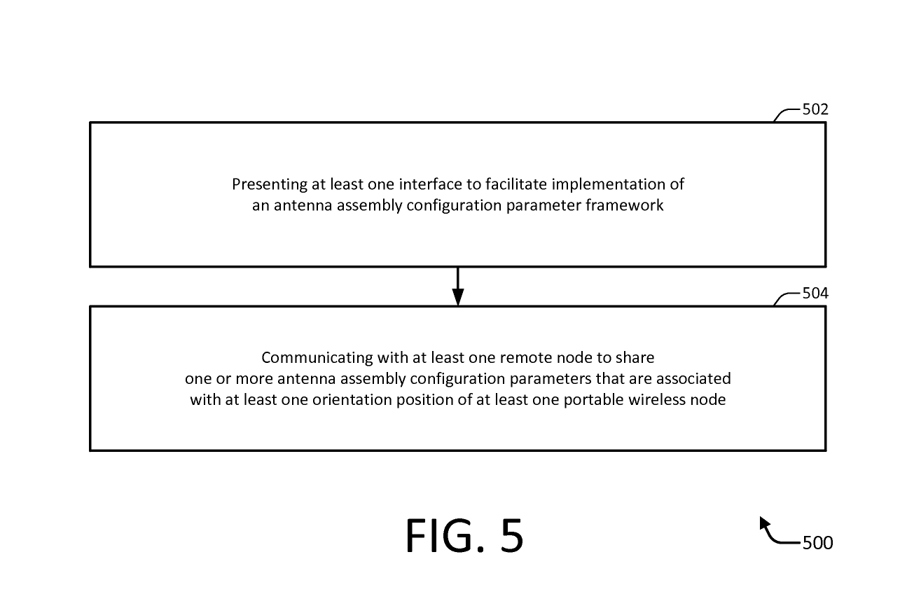

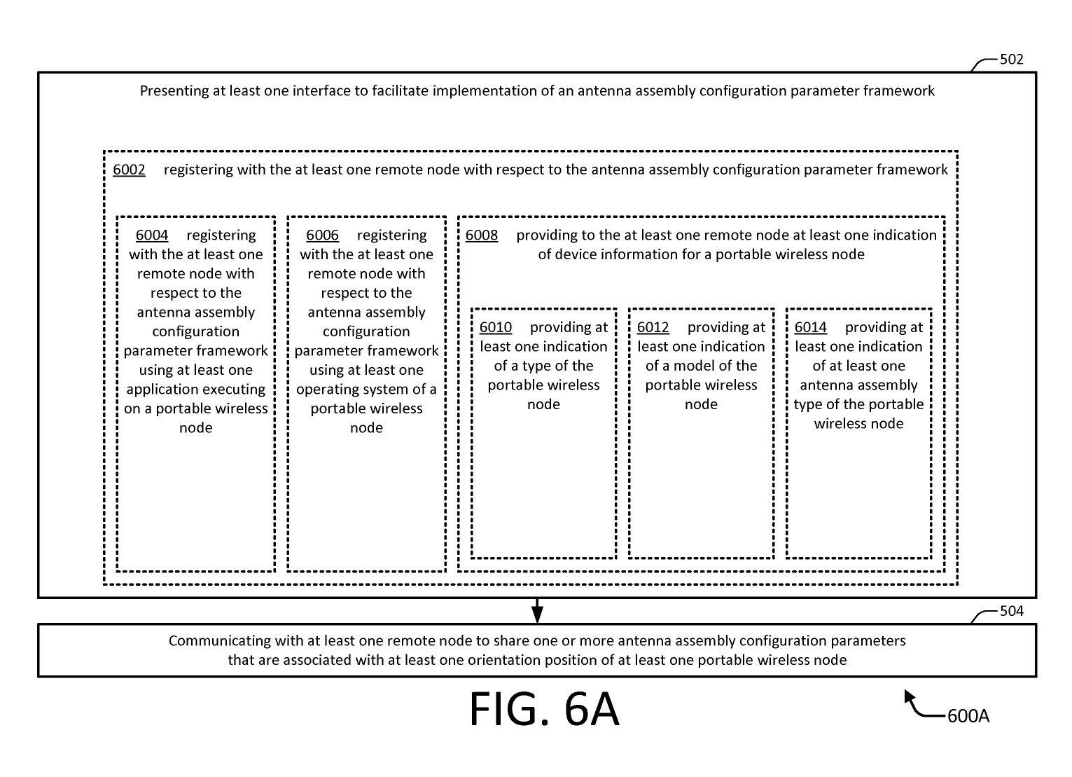

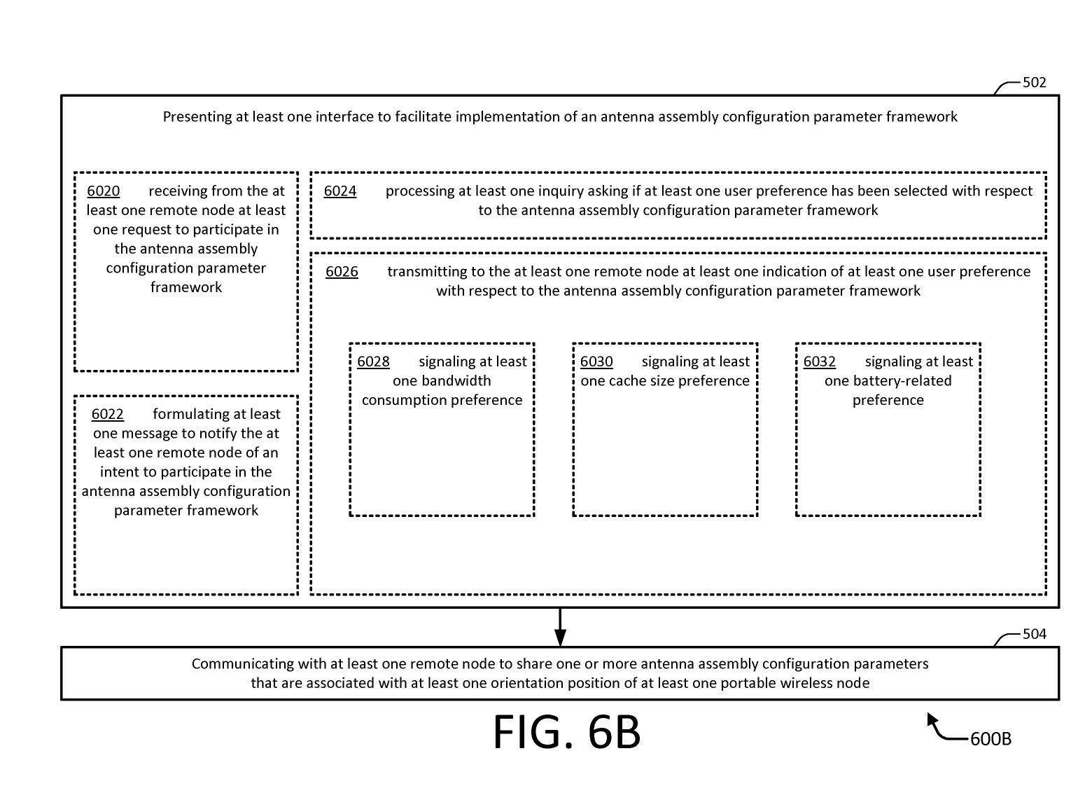

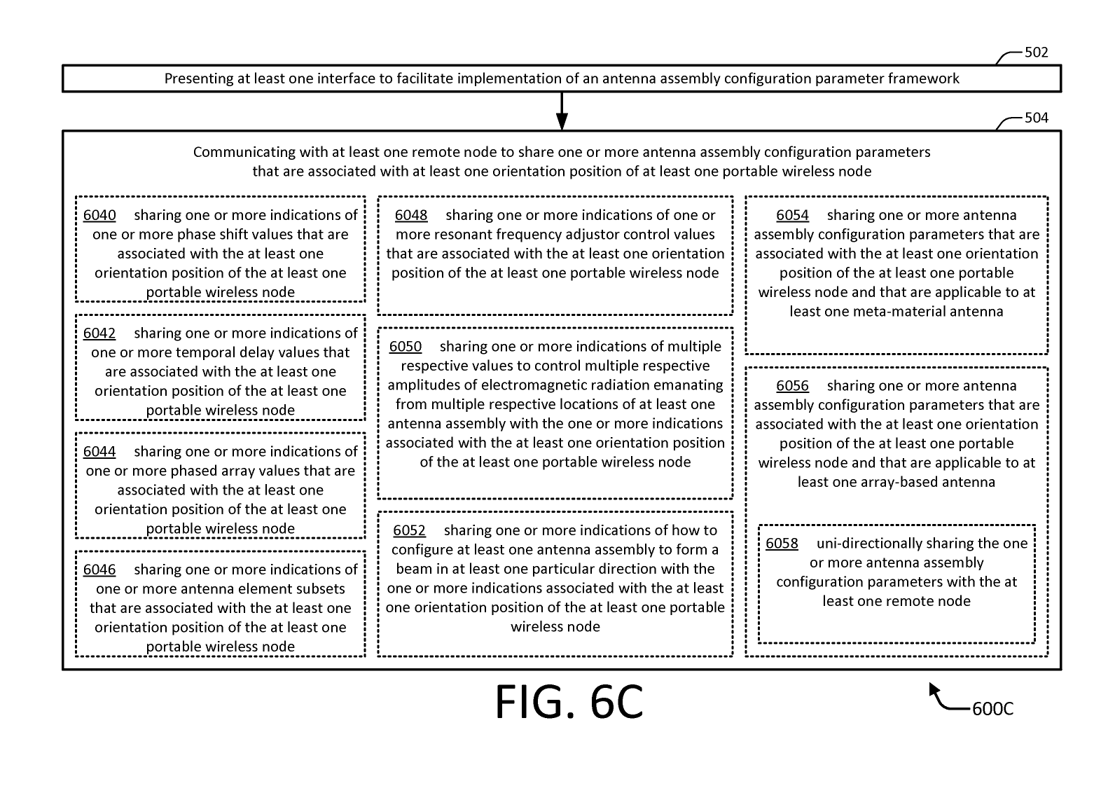

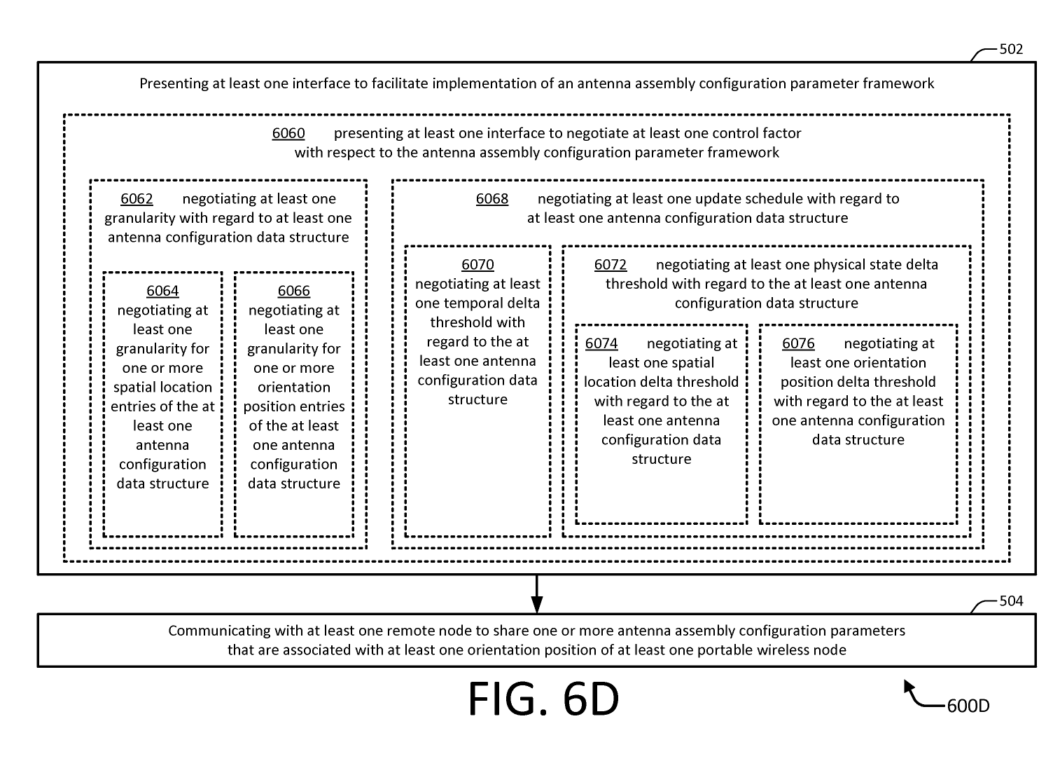

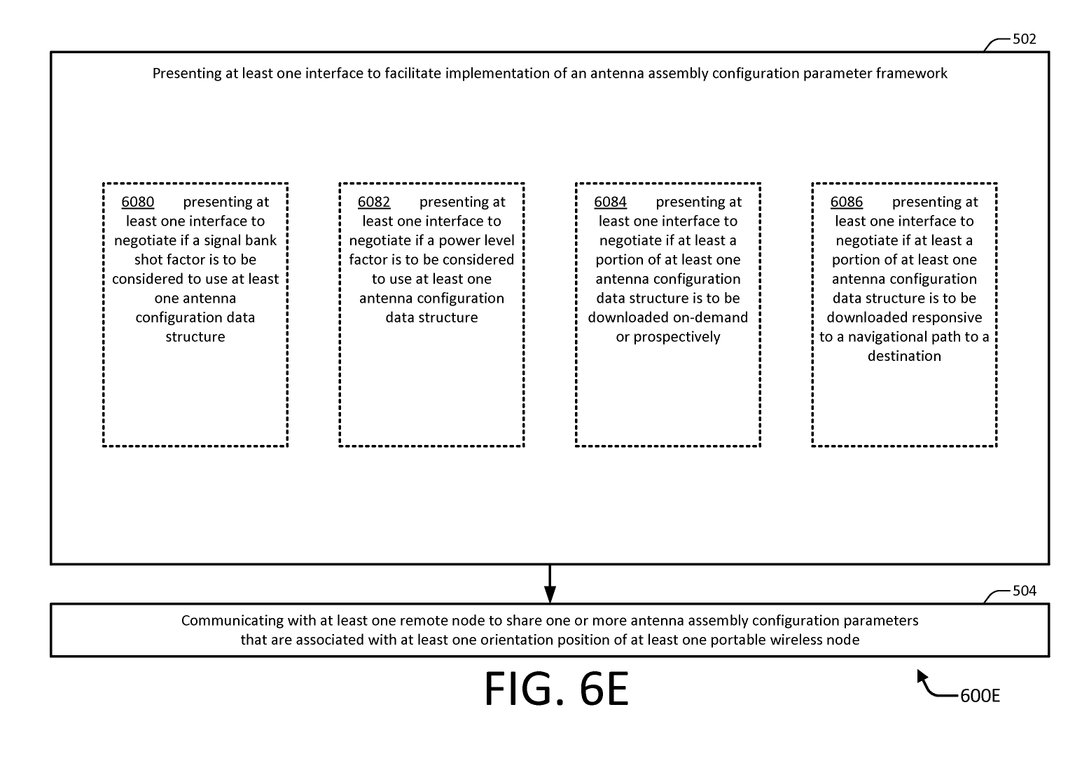

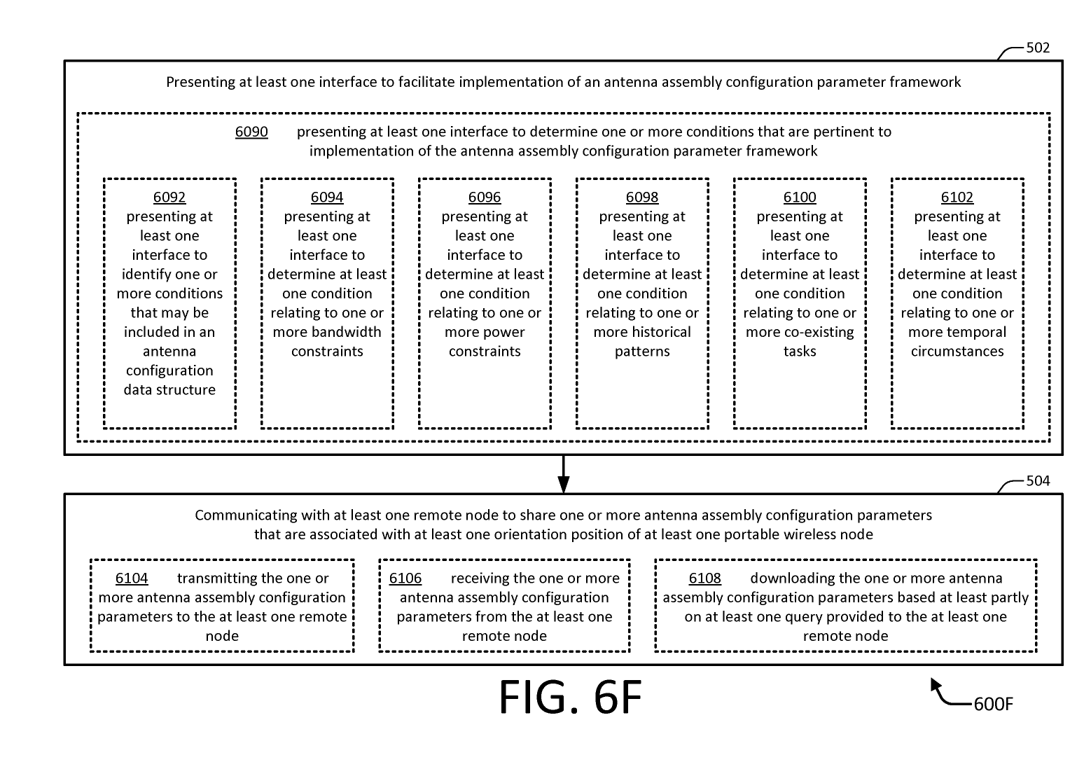

FIGS. 4B-4D are schematic diagrams 400B-400D that include at least one example device and that depict example scenarios for supporting antenna assembly configuration network infrastructure in accordance with certain example embodiments. As shown in FIGS. 4B-4D, by way of example but not limitation, one or more of schematic diagrams 400B-400D may include at least one portable wireless node (PWN) 1002P, at least one interface presentation module 402, at least one parameter sharing communication module 404, at least one interface 410, at least one remote node 412, at least one antenna assembly configuration parameter framework 414, at least one antenna assembly configuration parameter 1070, or at least one orientation position 1072OP. Each of schematic diagrams 400B-400D may include alternative or additional depictions, which may relate to supporting antenna assembly configuration network infrastructure, as described herein. In addition to or in alternative to description herein below with specific reference to FIGS. 4B-4D, illustrated aspects of schematic diagrams 400B-400D may be relevant to example description with reference to any one or more of FIG. 5 or 6A-6F. However, claimed subject matter is not limited to any particular described embodiments, implementations, examples, etc.

As shown in FIG. 4B, by way of example but not limitation, schematic diagram 400B may further include at least one application 420, at least one operating system 422, at least one indication 424, at least some device information 426, at least one portable wireless node type 428, at least one portable wireless node model 430, at least one antenna assembly type 432, at least one request 434, at least one message 436, at least one inquiry 438, at least one user preference 440, at least one indication 442, at least one bandwidth consumption preference 444, at least one cache size preference 446, at least one battery-related preference 448, at least one phase shift value 450, at least one temporal delay value 452, at least one phased array value 454, at least one antenna element subset 456, at least one resonant frequency adjustor control value 458, at least one directional beamforming indication for an antenna assembly 460, at least one antenna assembly 1006, at least one meta-material antenna 1006MM, or at least one array-based antenna 1006AR/1006PH. Additional or alternative description that may be relevant to schematic diagram 400B is provided herein below with particular reference to one or more of any of FIGS. 6A-6F.

As shown in FIG. 4C, by way of example but not limitation, schematic diagram 400C may further include at least one control factor 462, at least one granularity 464, at least one spatial location entry 466, at least one orientation position entry 468, at least one update schedule 470, at least one temporal delta threshold 472, at least one physical state delta threshold 474, at least one spatial location delta threshold 476, at least one orientation position delta threshold 478, at least one signal bank shot 480, at least one power level 482, or at least one navigational path 484. Additional or alternative description that may be relevant to schematic diagram 400C is provided herein below with particular reference to one or more of any of FIGS. 6A-6F.

As shown in FIG. 4D, by way of example but not limitation, schematic diagram 400D may further include at least one condition 1072, at least one antenna configuration data structure 1008, at least one bandwidth constraint 486, at least one power constraint 488, at least one historical pattern 490, at least one co-existing task 492, at least one temporal circumstance 494, or at least one query 496. Additional or alternative description that may be relevant to schematic diagram 400D is provided herein below with particular reference to one or more of any of FIGS. 6A-6F.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 5 is a flow diagram 500 illustrating an example method for at least one device with regard to supporting antenna assembly configuration network infrastructure in accordance with certain example embodiments. As illustrated, flow diagram 500 may include any of operations 502-504. Although operations 502-504 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 500 may be performed so as to be fully or partially overlapping with other operation(s). For certain example embodiments, one or more operations of flow diagram 500 may be performed by at least one device, such as a portable wireless node 1002P or at least a portion thereof, such as one or more modules thereof. However, claimed subject matter is not limited to any particular described embodiments, implementations, examples, etc.

For certain example embodiments, a method for supporting antenna assembly configuration network infrastructure (e.g., that may include, involve, address, react to, pertain to, or a combination thereof, etc. or other otherwise relate to frequency accommodation), which method may be at least partially implemented using hardware (e.g., circuitry, at least one processor, processor-accessible memory, at least one module, or a combination thereof, etc.) of a device such as a portable wireless node, may include an operation 502 or an operation 504. An operation 502 may be directed at least partially to presenting at least one interface to facilitate implementation of an antenna assembly configuration parameter framework. For certain example implementations, at least one device (e.g., a portable wireless node 1002P, such as a smart phone device) may present (e.g., expose, offer, make available, produce, create, interact with, provide, enable access to, or a combination thereof, etc. via at least one presentation 406) at least one interface 410 (e.g., data conduit, information throughput avenue, application programming interface (API), application binary interface (ABI), communication capability, input interface, output interface, expression of available parameters, negotiation protocol, mechanism to coordinate exchange of data, or a combination thereof, etc.) to facilitate (e.g., enable, make easier, assist progress of, expedite, or a combination thereof, etc.) implementation (e.g., realization, effectuation, activation, operation, exploitation, administration, utilization, or a combination thereof, etc.) of an antenna assembly configuration parameter framework 414 (e.g., foundation, schema, structure, frame, shell, or a combination thereof, etc. that pertains to a cloud-based, cloud-enabled, database-including (e.g., a storage solution that provides responses to queries, such as an structured query language (SQL) database), server-employing, or a combination thereof, etc. implementation or usage of antenna assembly configuration parameters that promotes their manipulation, dissemination, organization, storage, application, handling, administration, or a combination thereof, etc.). By way of example but not limitation, at least one portable wireless node may present at least one interface to facilitate implementation of an antenna assembly configuration parameter framework (e.g., a mobile wireless node, such as an Apple iPhone, may expose to external parties or devices a mechanism that enables the mobile wireless node to participate in a cloud-capable system that orchestrates a dissemination via uploading or downloading of one or more antenna assembly configuration parameters, such as antenna patch selection or phase shift indications).

For certain example embodiments, an operation 504 may be directed at least partially to communicating with at least one remote node to share one or more antenna assembly configuration parameters that are associated with at least one orientation position of at least one portable wireless node. For certain example implementations, at least one device (e.g., a portable wireless node 1002P, such as a tablet computer) may communicate (e.g., impart, transmit, receive, exchange, broadcast, accept delivery, send, or a combination, thereof, etc. via at least one communication 408 information, data, knowledge, bits, or a combination thereof, etc.) with at least one remote node 412 (e.g., a telecommunications node 1014, an internet node 1016, a gateway, a server, a device providing cloud-computing services, or a combination thereof, etc.) to share (e.g., give, take, participate in using or distributing, utilize jointly, mete out, forward, provide, procure, unilaterally transmit or receive, bi-directionally exchange, provide, offer, or a combination thereof, etc.) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, one or more phase delays, meta-material antenna control signal values, phased-array antenna operational inputs, antenna element or junction selection indicators, or a combination thereof, etc.) that are associated with (e.g., that correspond to, that are linked to, that relate to, that pertain to, that are matched with, that are mated to, that are derived from, or a combination thereof, etc.) at least one orientation position 1072OP (e.g., a direction that is being faced toward or pointed to, a vector in space, an Euler value, a roll or pitch or yaw value, a rotational position, an angle of inclination or declination, or a combination thereof, etc.) of at least one portable wireless node (e.g., a mobile device, a mobile phone, a tablet, a slate computer, a phablet, a portable gaming device, a smartphone, a notebook computer, a mobile repeater, a UE, a MS, a laptop computer, a hand-held radio, a walker-talkie, a roving transceiver, a wireless device that moves under its own power or control (e.g., an autonomous motorized robot or an unmanned aerial vehicle (UAV)), a wireless device that moves under the power or control of another entity (e.g., a vehicle or a remotely-piloted craft that is controlled by a passenger or a remote human or by a remote machine), or a combination thereof, etc.). By way of example but not limitation, at least one portable wireless node may communicate with at least one remote node to share one or more antenna assembly configuration parameters that are associated with at least one orientation position of at least one portable wireless node (e.g., a mobile wireless node, such as a Samsung Galaxy Tab tablet computer, may engage in a transmission with a cloud server to provide or may engage in a reception with a cloud server to procure an identification of at least one direction of electromagnetic interaction that is associated with an angle at which the tablet is propped up on a table at a known geospatial location).

FIGS. 6A-6F depict example additions or alternatives for a flow diagram of FIG. 5 in accordance with certain example embodiments. As illustrated, flow diagrams of FIGS. 6A-6F may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently or along with one or more other operations). Also, at least some operation(s) of flow diagrams of FIGS. 6A-6F may be performed so as to be fully or partially overlapping with other operation(s). For certain example embodiments, one or more operations of flow diagrams 600A-600F (of FIGS. 6A-6F) may be performed by at least one device (e.g., a portable wireless node 1002P or at least a portion thereof, such as one or more modules thereof). However, claimed subject matter is not limited to any particular described embodiments, implementations, examples, etc.

FIG. 6A illustrates a flow diagram 600A having any one or more of example operations 6002-6014. For example, an operation 502 may include an operation 6002 of registering with the at least one remote node with respect to the antenna assembly configuration parameter framework. For instance, at least one portable wireless node (e.g., a portable wireless node 1002P, such as an Android mobile phone) may register with (e.g., make contact with, announce presence to, log into, initialize communication with, notify availability to, authenticate with, authorize data exchange with, provide identification of device or user to, validate connection with, or a combination thereof, etc.) at least one remote node 412 (e.g., a Google server) with respect to an antenna assembly configuration parameter framework 414 (e.g., a system to enable antenna assembly configuration parameter exchanges).

For example, an operation 6002 may include an operation 6004 of registering with the at least one remote node with respect to the antenna assembly configuration parameter framework using at least one application executing on a portable wireless node. For instance, at least one portable wireless node (e.g., a portable wireless node 1002P, such as an Apple iPad) may register with (e.g., announce activation to) at least one remote node 412 (e.g., an Apple server) with respect to an antenna assembly configuration parameter framework 414 (e.g., a database of antenna assembly configuration parameters) using at least one application 420 (e.g., an app, a native app, a web browser app, a downloaded app, a set of instructions, a program, or a combination thereof, etc.) executing on a portable wireless node 1002P (e.g., an Apple iPad).

For example, an operation 6002 may include an operation 6006 of registering with the at least one remote node with respect to the antenna assembly configuration parameter framework using at least one operating system of a portable wireless node. For instance, at least one portable wireless node (e.g., a portable wireless node 1002P, such as a Samsung Galaxy phone) may register with (e.g., log into) at least one remote node 412 (e.g., a network-side device providing a Samsung cloud service) with respect to an antenna assembly configuration parameter framework 414 (e.g., a Samsung cloud service disseminating antenna assembly configuration parameters between and among Samsung devices) using at least one operating system (OS) 422 (e.g., an Android OS, a set of instructions incorporated into software that manages computing resources, a Samsung Tizen operating system, or a combination thereof, etc.) of a portable wireless node 1002P (e.g., a Samsung Galaxy phone).

For example, an operation 6002 may include an operation 6008 of providing to the at least one remote node at least one indication of device information for a portable wireless node. For instance, at least one portable wireless node (e.g., a portable wireless node 1002P, such as an Apple iPhone) may provide (e.g., transmit, reference, supply, proffer, make available, or a combination thereof, etc.) to at least one remote node 412 (e.g., a virtual server at a cloud computing facility) at least one indication 424 (e.g., a description, a designation, an expression, a representation, an indirect identification, a direct identification, a code, a universal resource locator (URL) providing a reference or linkage to, a signal, a value, or a combination thereof, etc.) of device information 426 (e.g., device type, device make, device model, antenna assembly type, frequency capacity, wireless standard capabilities, wireless service provider, battery level, current power source, or a combination thereof, etc.) for a portable wireless node 1002P (e.g., an Apple iPhone).

For example, an operation 6008 may include an operation 6010 of providing at least one indication of a type of the portable wireless node. For instance, at least one portable wireless node (e.g., a portable wireless node 1002P, such as a Nokia smart phone) may provide (e.g., report) at least one indication 424 (e.g., a description, a designation, an expression, a representation, an indirect identification, a direct identification, a code, a universal resource locator (URL) providing a reference or linkage to, a signal, a value, or a combination thereof, etc.) of a type 428 (e.g., phone, phablet, tablet, laptop, portable speaker, ground vehicle, aerial vehicle, or a combination thereof, etc.) of a portable wireless node 1002P (e.g., a Nokia smart phone).

For example, an operation 6008 may include an operation 6012 of providing at least one indication of a model of the portable wireless node. For instance, at least one portable wireless node (e.g., a portable wireless node 1002P, such as a Huawei smart phone) may provide (e.g., transmit) at least one indication 424 (e.g., a description, a designation, an expression, a representation, an indirect identification, a direct identification, a code, a universal resource locator (URL) providing a reference or linkage to, a signal, a value, or a combination thereof, etc.) of a model 430 (e.g., Asus laptop, Apple iPad 5^{th} Generation or iPhone 6, Dell Inspiron 9200, HP tablet, HTC One smart phone, Huawei feature phone, LG Escape 2013, Motorola Moto X, Nokia 928, Pantech Flex, RIM Blackberry Q10, Samsung Galaxy S4 or Tab 5, a number representing a model, a serial number, or a combination thereof, etc.) of a portable wireless node 1002P (e.g., a Huawei smart phone).

For example, an operation 6008 may include an operation 6014 of providing at least one indication of at least one antenna assembly type of the portable wireless node. For instance, at least one portable wireless node (e.g., a portable wireless node 1002P, such as a wireless speaker) may provide (e.g., send wirelessly) at least one indication 424 (e.g., a description, a designation, an expression, a representation, an indirect identification, a direct identification, a code, a universal resource locator (URL) providing a reference or linkage to, a signal, a value, or a combination thereof, etc.) of at least one antenna assembly type 432 (e.g., 4-part patch antenna, antenna array with 16 elements, phased array antenna, meta-material antenna with 12 control signal antenna junctions, dipole antenna and phased array antenna, 5 GHz patch antenna and 60 GHz meta-material antenna, or a combination thereof, etc.) of a portable wireless node 1002P (e.g., a wireless speaker).

FIG. 6B illustrates a flow diagram 600B having any one or more of example operations 6020-6032. For example, an operation 502 may include an operation 6020 of receiving from the at least one remote node at least one request to participate in the antenna assembly configuration parameter framework. For instance, at least one portable wireless node (e.g., a portable wireless node 1002P, such as a Motorola Droid) may receive (e.g., accept, decode, demodulate, down-convert, detect, obtain from or via a communication or transmission from another, route from an antenna or antenna element, take into possession wirelessly, or a combination thereof, etc.) from at least one remote node 412 (e.g., a Verizon network gateway) at least one request 434 (e.g., message, inquiry, packet asking for cooperation, or a combination thereof, etc.) to participate in (e.g., take part in, cooperate with, join in, or a combination thereof, etc.) an antenna assembly configuration parameter framework 414 (e.g., a Verizon instituted program to share parameters).

For example, an operation 502 may include an operation 6022 of formulating at least one message to notify the at least one remote node of an intent to participate in the antenna assembly configuration parameter framework. For instance, at least one portable wireless node (e.g., a portable wireless node 1002P, such as a Microsoft Windows Phone-based smart phone) may formulate (e.g., prepare, create, compose, construct, or a combination thereof, etc.) at least one message 436 (e.g., communication, packet, signal, group of transmitted bits, announcement, or a combination thereof, etc.) to notify (e.g., inform, announce to, communicate to, or a combination thereof, etc.) at least one remote node 412 (e.g., a Microsoft server) of an intent (e.g., desire, expectation, plan, or a combination thereof, etc.) to participate in (e.g., take part in, cooperate with, join in, or a combination thereof, etc.) an antenna assembly configuration parameter framework 414 (e.g., a cloud-based capability to disseminate known antenna assembly configuration parameters).

For example, an operation 502 may include an operation 6024 of processing at least one inquiry asking if at least one user preference has been selected with respect to the antenna assembly configuration parameter framework. For instance, at least one portable wireless node (e.g., a portable wireless node 1002P, such as an Apple iPod) may process (e.g., analyze, examine, evaluate, consider, or a combination thereof, etc.) at least one inquiry 438 (e.g., request for information or confirmation, interrogatory, question, or a combination thereof, etc.) asking if at least one user preference 440 (e.g., choice, activated option, selection, thing that has been prioritized, or a combination thereof, etc. pertaining to a single value or variable or Boolean indicator, to multiple selected options, to a range of values such as 10-15, or a combination thereof, etc.) has been selected (e.g., activated, indicated, marked, pressed, or a combination thereof, etc.) with respect to an antenna assembly configuration parameter framework 414 (e.g., a configuration parameter paradigm to expeditiously enact antenna assembly configuration parameters).

For example, an operation 502 may include an operation 6026 of transmitting to the at least one remote node at least one indication of at least one user preference with respect to the antenna assembly configuration parameter framework. For instance, at least one portable wireless node (e.g., a portable wireless node 1002P, such as an Android Nexus tablet computer) may transmit (e.g., send, communicate by wire, communicate wirelessly, frequency up-convert, modulate, encode, propagate, emanate from an emitter or antenna or network port, or a combination thereof, etc.) to at least one remote node 412 (e.g., at least part of a distributed Google server farm) at least one indication 442 (e.g., a description, a designation, an expression, a representation, an indirect identification, a direct identification, a code, a universal resource locator (URL) providing a reference or linkage to, a signal, a value, or a combination thereof, etc.) of at least one user preference 440 (e.g., choice, activated option, selection, thing that has been prioritized, or a combination thereof, etc. pertaining to a single value or variable or Boolean indicator, to multiple selected options, to a range of values such as 5-10 degree increments, or a combination thereof, etc.) with respect to an antenna assembly configuration parameter framework 414 (e.g., a distributed database of antenna assembly configuration parameters that may be disseminated).

For example, an operation 6026 may include an operation 6028 of signaling at least one bandwidth consumption preference. For instance, at least one portable wireless node (e.g., a portable wireless node 1002P, such as a mobile phone) may signal (e.g., provide an indication, communicate information, make known, warn, give a sign to, or a combination thereof, etc. regarding) at least one bandwidth consumption (e.g., bits per second, bytes per day, data amount consumed on cellular connection—such as whether permitted or limited if permitted, data amount consumed on Wi-Fi connection, downloaded parameter acquisition versus uploaded parameter proffering, or a combination thereof, etc.) preference 444 (e.g., choice, activated option, selection, thing that has been prioritized, or a combination thereof, etc. separately or in conjunction with an unrelated or interrelated preference).

For example, an operation 6026 may include an operation 6030 of signaling at least one cache size preference. For instance, at least one portable wireless node (e.g., a portable wireless node 1002P, such as a tablet) may signal (e.g., provide an indication, communicate information, make known, warn, give a sign to, or a combination thereof, etc. regarding) at least one cache size (e.g., position of a slider or other UI feature representing size, size in bytes, permitted size of preloading for offline access enablement, size of downloadable cache that is accepted, size of experimentally-determined configuration parameters that are retained by a device, or a combination thereof, etc.) preference 446 (e.g., choice, activated option, selection, thing that has been prioritized, or a combination thereof, etc. separately or in conjunction with an unrelated or interrelated preference).

For example, an operation 6026 may include an operation 6032 of signaling at least one battery-related preference. For instance, at least one portable wireless node (e.g., a portable wireless node 1002P, such as a smart phone) may signal (e.g., provide an indication, communicate information, make known, warn, give a sign to, or a combination thereof, etc. regarding) at least one battery-related (e.g., battery status, indication that experimentally-determined parameters are uploaded on certain conditions—such as when plugged in or battery above a certain threshold, frequency of parameter updates or updating being dependent on battery status—such as more frequent determinations being permitted if battery level is high, or a combination thereof, etc.) preference 448 (e.g., choice, activated option, selection, thing that has been prioritized, or a combination thereof, etc. separately or in conjunction with an unrelated or interrelated preference, such as a preference that merges or fuses bandwidth and battery options or that trades cache size for battery life).

FIG. 6C illustrates a flow diagram 600C having any one or more of example operations 6040-6058. For example, an operation 504 may include an operation 6040 of sharing one or more indications of one or more phase shift values that are associated with the at least one orientation position of the at least one portable wireless node. For instance, at least one portable wireless node (e.g., a portable wireless node 1002P, such as a mobile phone) may share (e.g., transmit, receive, retrieve from memory for forwarding, store into memory after accepting from an external source, or a combination thereof, etc.) one or more indications 424 (e.g., identification) of one or more phase shift values 450 (e.g., a number or numerical range, a setting implementing a phase shift, one or more switches or processing to realize a phase shift, a phase delay value, an identification of how or how much to change a phase or a timing of a signal, a selection or length of a signal phase delay line, or a combination thereof, etc.) that are associated with at least one orientation position 1072OP (e.g., a 45 degree angle tilt) of at least one portable wireless node (e.g., a same or a different mobile phone).

For example, an operation 504 may include an operation 6042 of sharing one or more indications of one or more temporal delay values that are associated with the at least one orientation position of the at least one portable wireless node. For instance, at least one portable wireless node (e.g., a portable wireless node 1002P, such as a tablet computer) may share (e.g., transmit, receive, retrieve from memory for forwarding, store into memory after accepting from an external source, or a combination thereof, etc.) one or more indications 424 (e.g., a listing) of one or more temporal delay values 452 (e.g., a number or numerical range, a setting implementing a temporal delay, one or more switches or processing to realize a temporal delay, a time shifting value, an identification of how or how much to change a timing or a phase of a signal, a selection or length of a signal timing delay line, or a combination thereof, etc.) that are associated with at least one orientation position 1072OP (e.g., at least one number representing at least one Euler value) of at least one portable wireless node (e.g., a different tablet computer or a smart phone).

For example, an operation 504 may include an operation 6044 of sharing one or more indications of one or more phased array values that are associated with the at least one orientation position of the at least one portable wireless node. For instance, at least one portable wireless node (e.g., a portable wireless node 1002P, such as a Nokia Lumia phone) may share (e.g., transmit, receive, retrieve from memory for forwarding, store into memory after accepting from an external source, or a combination thereof, etc.) one or more indications 424 (e.g., description) of one or more phased array values 454 (e.g., a number or numerical range, a setting implementing directionality or beamforming, one or more switches or processing to realize a directed or beamformed signal, an explanation of how or how much to change a direction or a shape of a signal wave or beam, an identification of which antenna patch or antenna patches to employ, a matrix of values to program operation of an array-based antenna, or a combination thereof, etc.) that are associated with at least one orientation position 1072OP (e.g., a cardinal direction such as West to which a screen is facing) of at least one portable wireless node (e.g., the Nokia Lumia phone or a RIM Playbook tablet).

For example, an operation 504 may include an operation 6046 of sharing one or more indications of one or more antenna element subsets that are associated with the at least one orientation position of the at least one portable wireless node. For instance, at least one portable wireless node (e.g., a portable wireless node 1002P, such as a portable screen communicating with a media streaming device) may share (e.g., transmit, receive, retrieve from memory for forwarding, store into memory after accepting from an external source, or a combination thereof, etc.) one or more indications 424 (e.g., look-up values) of one or more antenna element subsets 456 (e.g., a listing or group of antenna elements, a listing or group of antenna junctions coupled to antenna elements, a subset of—or less than all of—an available set of antenna elements, a matrix or process coupling less than all available antenna elements to a receive or transmit chain, or a combination thereof, etc.) that are associated with at least one orientation position 1072OP (e.g., 30 degrees from vertical and 45 degrees from extending North-to-South) of at least one portable wireless node (e.g., the same portable screen or an associated portable speaker).

For example, an operation 504 may include an operation 6048 of sharing one or more indications of one or more resonant frequency adjustor control values that are associated with the at least one orientation position of the at least one portable wireless node. For instance, at least one portable wireless node (e.g., a portable wireless node 1002P, such as an Android smart phone) may share (e.g., transmit, receive, retrieve from memory for forwarding, store into memory after accepting from an external source, or a combination thereof, etc.) one or more indications 424 (e.g., signifiers or numerical values) of one or more resonant frequency adjustor control values 458 (e.g., a number or numerical range, a current, a voltage level, a representation of control input to set a resonant frequency of at least one position on a surface scattering antenna, a matrix or process to establish one or more resonant frequencies of a meta-material antenna—such as for a resonant frequency adjustor 1080 of a meta-material antenna element 1078 thereof (e.g., of FIG. 1C), a setting to control at least a portion of at least one tuner for a meta-material antenna, or a combination thereof, etc.) that are associated with at least one orientation position 1072OP (e.g., wherein a normal vector for the screen is 180 degrees opposite to that of a detected gravitational force vector) of at least one portable wireless node (e.g., the same Android smart phone or a different Android smart phone or an Apple iPhone).

For example, an operation 504 may include an operation 6050 of sharing one or more indications of multiple respective values to control multiple respective amplitudes of electromagnetic radiation emanating from multiple respective locations of at least one antenna assembly with the one or more indications associated with the at least one orientation position of the at least one portable wireless node. For instance, at least one portable wireless node (e.g., a portable wireless node 1002P, such as a tablet computer) may share (e.g., transmit, receive, retrieve from memory for forwarding, store into memory after accepting from an external source, or a combination thereof, etc.) one or more indications 424 of (e.g., code for or reference to) multiple respective values (e.g., numeral or variable name or table entry) to control multiple respective amplitudes (e.g., magnitude) of electromagnetic radiation (e.g., radio frequency waves) emanating (e.g., transmitting) from multiple respective locations (e.g., position or coordinate or part or portion) of at least one antenna assembly 1006 (e.g., at least one antenna with one or more radiating elements, at least one meta-material antenna 1006MM, at least one array-based antenna 1006AR/1006PH, or a combination thereof, etc.) with one or more indications 424 associated with at least one orientation position 1072OP (e.g., lying flat and parallel to the earth with a “top” end pointing between 15 and 35 degrees east of north) of at least one portable wireless node (e.g., the same tablet computer or another tablet computer or a phablet).

For example, an operation 504 may include an operation 6052 of sharing one or more indications of how to configure at least one antenna assembly to form a beam in at least one particular direction with the one or more indications associated with the at least one orientation position of the at least one portable wireless node. For instance, at least one portable wireless node (e.g., a portable wireless node 1002P, such as an Apple iWatch) may share (e.g., transmit, receive, retrieve from memory for forwarding, store into memory after accepting from an external source, or a combination thereof, etc.) one or more indications 460 (e.g., phase shift value(s), temporal delay value(s), phased array value(s), antenna element subset(s), resonant frequency adjustor control value(s), direction or shape of electromagnetic coverage zone, patch antenna selection(s), antenna junction(s) utilized, or a combination thereof, etc.) of how to configure at least one antenna assembly 1006 to form a beam (e.g., a focused electromagnetic coverage area) in at least one particular direction (e.g., toward a particular fixed wireless node, in an identified emanation direction with respect to or away from a given portion or part of a portable wireless node, not omni-directionally, a hemispherical pattern (e.g., approximately 180 degrees), a narrow beam, less than 5 or 10 or 30 etc. arc degrees in width with respect to a designated vector, an identified azimuth angle, or a combination thereof, etc.) with one or more indications 460 associated with at least one orientation position 1072OP (e.g., up to three specified Euler rotational values) of at least one portable wireless node (e.g., an Apple iWatch or an Apple iPhone).

For example, an operation 504 may include an operation 6054 of sharing one or more antenna assembly configuration parameters that are associated with the at least one orientation position of the at least one portable wireless node and that are applicable to at least one meta-material antenna. For instance, at least one portable wireless node (e.g., a portable wireless node 1002P, such as a user equipment) may share (e.g., transmit, receive, retrieve from memory for forwarding, store into memory after accepting from an external source, or a combination thereof, etc.) one or more antenna assembly configuration parameters 1070 (e.g., voltage levels) that are associated with at least one orientation position 1072OP (e.g., an Euler angle) of at least one portable wireless node (e.g., a different portable wireless node, such as a mobile station) and that are applicable to at least one meta-material antenna 1006MM (e.g., a surface scattering antenna).

For example, an operation 504 may include an operation 6056 of sharing one or more antenna assembly configuration parameters that are associated with the at least one orientation position of the at least one portable wireless node and that are applicable to at least one array-based antenna. For instance, at least one portable wireless node (e.g., a portable wireless node 1002P, such as a phablet) may share (e.g., transmit, receive, retrieve from memory for forwarding, store into memory after accepting from an external source, or a combination thereof, etc.) one or more antenna assembly configuration parameters 1070 (e.g., phase shifts or beam shape or transmission direction) that are associated with at least one orientation position 1072OP (e.g., a screen facing within 30 degrees of north and a vector along a length of a housing running within 15 degrees of parallel to a gravitational force) of at least one portable wireless node 1002P (e.g., a same phablet) and that are applicable to at least one array-based antenna 1006AR/1006PH/1006* (e.g., a beamforming, phased-array antenna).

For example, an operation 6056 may include an operation 6058 of uni-directionally sharing the one or more antenna assembly configuration parameters with the at least one remote node. For instance, at least one portable wireless node (e.g., a portable wireless node 1002P, such as a portable Wi-Fi-creating device) may uni-directionally (e.g., in at least one direction, send upstream to a server, acquire from an upstream device, or a combination thereof, etc.) share (e.g., transmit, receive, retrieve from memory for forwarding, store into memory after accepting from an external source, or a combination thereof, etc.) one or more antenna assembly configuration parameters 1070 (e.g., a description of antenna operation to produce a 15 degree beam pattern in a specific cardinal direction, such as west-north-west) with at least one remote node 412 (e.g., a cloud server accessible via an internet).

FIG. 6D illustrates a flow diagram 600D having any one or more of example operations 6060-6076. For example, an operation 502 may include an operation 6060 of presenting at least one interface to negotiate at least one control factor with respect to the antenna assembly configuration parameter framework. For instance, at least one portable wireless node (e.g., a portable wireless node 1002P, such as a smart phone or a tablet) may present (e.g., expose, offer, make available, produce, create, interact with, provide, enable access to, or a combination thereof, etc.) at least one interface 410 (e.g., data conduit, information throughput avenue, API, ABI, communication capability, input interface, output interface, expression of available parameters, mechanism to coordinate exchange of data, or a combination thereof, etc.) to negotiate (e.g., request, confirm, suggest, stipulate, offer, counter-offer, respond to invitation, modify suggestion, process direction regarding, receive a term, or a combination thereof, etc.) at least one control factor 462 (e.g., variable, aspect affecting something, value impacting performance, setting to guide operation, determinant, component contributing to implementation, or a combination thereof, etc.) with respect to an antenna assembly configuration parameter framework 414 (e.g., foundation, schema, structure, frame, shell, or a combination thereof, etc. that pertains to a cloud-based or cloud-enabled implementation or usage of antenna assembly configuration parameters that promotes their manipulation, dissemination, organization, storage, application, handling, administration, or a combination thereof, etc.).

For example, an operation 6060 may include an operation 6062 of negotiating at least one granularity with regard to at least one antenna configuration data structure. For instance, at least one portable wireless node (e.g., a portable wireless node 1002P, such as an Apple iPad) may negotiate (e.g., select from among a set of offered options) at least one granularity 464 (e.g., density, number of entries per unit, size of spatial location, expanse of orientation position, number of orientation positions for a given spatial location, number of spatial locations for a given area or volume, size of, sparsity, or a combination thereof, etc.) with regard to at least one antenna configuration data structure 1008 (e.g., a database of conditions 1072 and antenna assembly configuration parameters 1070 (e.g., of FIG. 1E)).

For example, an operation 6062 may include an operation 6064 of negotiating at least one granularity for one or more spatial location entries of the at least one antenna configuration data structure. For instance, at least one portable wireless node (e.g., a portable wireless node 1002P, such as a Kindle Fire tablet) may negotiate (e.g., request) at least one granularity 464 (e.g., five feet square or cube) for one or more spatial location entries 466 (e.g., each geographical position or elevation position of a spatial location with respect to the earth may be five feet across) of at least one antenna configuration data structure 1008 (e.g., multiple associative entries of antenna assembly configuration parameters and conditions).

For example, an operation 6062 may include an operation 6066 of negotiating at least one granularity for one or more orientation position entries of the at least one antenna configuration data structure. For instance, at least one portable wireless node (e.g., a portable wireless node 1002P, such as a Nokia smart phone) may negotiate (e.g., transmit an offer) at least one granularity 464 (e.g., 30 degrees) for one or more orientation position entries 468 (e.g., a different antenna assembly configuration parameter may be determined or stored for each 30 degrees of rotation) of at least one antenna configuration data structure 1008 (e.g., one or more conditions that are associated with at least one antenna assembly configuration parameter).

For example, an operation 6060 may include an operation 6068 of negotiating at least one update schedule with regard to at least one antenna configuration data structure. For instance, at least one portable wireless node (e.g., a portable wireless node 1002P, such as a Motorola tablet) may negotiate (e.g., accept a directive) at least one update schedule 470 (e.g., an indication of when or how often an update is to occur, an indication of where or at what distance an update is to occur, a setting prompting a new determination or acquisition of an antenna assembly configuration parameter, an indication of how much time is to elapse between updates, an indication of how much movement is to occur between updates, or a combination thereof, etc.) with regard to at least one antenna configuration data structure 1008 (e.g., a table linking physical states with respective phase shifts).

For example, an operation 6068 may include an operation 6070 of negotiating at least one temporal delta threshold with regard to the at least one antenna configuration data structure. For instance, at least one portable wireless node (e.g., a portable wireless node 1002P, such as an Apple iPhone) may negotiate (e.g., modify an initial received suggestion) at least one temporal delta threshold 472 (e.g., a time between successive updates, a minimum time before an update is requested or provided, a time that elapses before a physical state delta threshold is checked, 100 milliseconds, 10 seconds, or a combination thereof, etc.) with regard to at least one antenna configuration data structure 1008 (e.g., at least a portion of a data base).

For example, an operation 6068 may include an operation 6072 of negotiating at least one physical state delta threshold with regard to the at least one antenna configuration data structure. For instance, at least one portable wireless node (e.g., a portable wireless node 1002P, such as a Samsung Galaxy tablet) may negotiate (e.g., engage in a series of offers and counter-offers) at least one physical state delta threshold 474 (e.g., a physical distance moved before an update is requested or provided, an amount of distance that prompts an update acquisition, or a combination thereof, etc.) with regard to at least one antenna configuration data structure 1008 (e.g., at least one entry associating an environmental factor with selection of an antenna for use).

For example, an operation 6072 may include an operation 6074 of negotiating at least one spatial location delta threshold with regard to the at least one antenna configuration data structure. For instance, at least one portable wireless node (e.g., a portable wireless node 1002P, such as an Amazon Kindle phone) may negotiate (e.g., stipulate) at least one spatial location delta threshold 476 (e.g., one centimeter, six inches, four feet, 2 meters, fraction or multiple of wavelength using for communication—such as bandwidth or standard dependent, or a combination thereof, etc.) with regard to at least one antenna configuration data structure 1008 (e.g., at least a portion of a distributed database linking conditions that may be experienced by a portable wireless device with antenna assembly configuration parameters).

For example, an operation 6072 may include an operation 6076 of negotiating at least one orientation position delta threshold with regard to the at least one antenna configuration data structure. For instance, at least one portable wireless node (e.g., a portable wireless node 1002P, such as an Android-based entertainment appliance) may negotiate (e.g., respond to a request for) at least one orientation position delta threshold 478 (e.g., 0.5 degrees, 5 degrees in any direction, 0.5 radians, a total of 12 degrees summed across three rotational axes, 30 degrees, or a combination thereof, etc.) with regard to at least one antenna configuration data structure 1008 (e.g., at least a portion of a distributed database linking conditions with antenna assembly configuration parameters that may be applied or implemented by a portable wireless device).

FIG. 6E illustrates a flow diagram 600E having any one or more of example operations 6080-6086. For example, an operation 502 may include an operation 6080 of presenting at least one interface to negotiate if a signal bank shot factor is to be considered to use at least one antenna configuration data structure. For instance, at least one portable wireless node (e.g., a portable wireless node 1002P, such as a tablet computer) may present (e.g., expose) at least one interface 410 (e.g., data conduit) to negotiate (e.g., request) if a signal bank shot 480 (e.g., a signal reflected off of a wall, a signal that is planned to be received from a targeted or intended reflection, an electromagnetic transmission that is bounced off of an object, or a combination thereof, etc.) factor (e.g., impactful variable, affecting aspect, value impacting performance, setting to guide operation, determinant, component contributing to implementation, something affecting result, or a combination thereof, etc.) is to be considered (e.g., evaluated, identified, marked, contemplated with reference to, relied on as part of a decision, or a combination thereof, etc.) to use (e.g., employ, extract a parameter from, put into service, operate an antenna assembly at least partially based on, or a combination thereof, etc.) at least one antenna configuration data structure 1008 (e.g., a database).

For example, an operation 502 may include an operation 6082 of presenting at least one interface to negotiate if a power level factor is to be considered to use at least one antenna configuration data structure. For instance, at least one portable wireless node (e.g., a portable wireless node 1002P, such as an unmanned aerial vehicle (UAV)) may present (e.g., make available) at least one interface 410 (e.g., data variable specification) to negotiate (e.g., make a counter-offer) if a power level 482 (e.g., power expended to communicate with a given counterpart wireless node, power to transmit or receive a particular bandwidth of data, size capacity of battery, remaining charge in energy terms, remaining charge in time, percentage of battery capacity remaining, or a combination thereof, etc.) factor (e.g., impactful variable, affecting aspect, value impacting performance, setting to guide operation, determinant, component contributing to implementation, something affecting result, or a combination thereof, etc.) is to be considered (e.g., evaluated, identified, marked, contemplated with reference to, relied on as part of a decision, or a combination thereof, etc.) to use (e.g., employ, extract a parameter from, put into service, operate an antenna assembly at least partially based on, or a combination thereof, etc.) at least one antenna configuration data structure 1008 (e.g., a linking of conditions to parameters).

For example, an operation 502 may include an operation 6084 of presenting at least one interface to negotiate if at least a portion of at least one antenna configuration data structure is to be downloaded on-demand or prospectively. For instance, at least one portable wireless node (e.g., a portable wireless node 1002P, such as a laptop computer) may present (e.g., create) at least one interface 410 (e.g., factor exchange protocol) to negotiate (e.g., stipulate) if at least a portion of at least one antenna configuration data structure 1008 (e.g., one or more entries associating antenna assembly configuration parameters with conditions) is to be downloaded (e.g., sent from cloud server to device or received at device from cloud server) on-demand (e.g., as needed or as a spatial location is reached by device) or prospectively (e.g., as a spatial location is approached—such as within a given threshold distance independent of or dependent on current direction, based on a location for a future calendar-scheduled event, or a combination thereof, etc.).

For example, an operation 502 may include an operation 6086 of presenting at least one interface to negotiate if at least a portion of at least one antenna configuration data structure is to be downloaded responsive to a navigational path to a destination. For instance, at least one portable wireless node (e.g., a portable wireless node 1002P, such as a smart phone) may present (e.g., interact with) at least one interface 410 (e.g., mechanism to negotiate protocols) to negotiate (e.g., respond to invitation) if at least a portion of at least one antenna configuration data structure 1008 (e.g., a set of phase shifts for a phased-array antenna in association with GPS coordinates and rotational angle for a device) is to be downloaded (e.g., retrieved from a remote internet server) responsive to a navigational path 484 (e.g., end point, beginning point, mapped coordinates, planned path between two points—such as a current location and an identified destination, locations that are starred, or a combination thereof, etc.) to a destination (e.g., address, place name, GPS coordinates, meeting location, or a combination thereof, etc.).

FIG. 6F illustrates a flow diagram 600F having any one or more of example operations 6090-6108. For example, an operation 502 may include an operation 6090 of presenting at least one interface to determine one or more conditions that are pertinent to implementation of the antenna assembly configuration parameter framework. For instance, at least one portable wireless node (e.g., a portable wireless node 1002P, such as a tablet having access to cellular wireless service) may present (e.g., expose, offer, make available, produce, create, interact with, provide, enable access to, or a combination thereof, etc.) at least one interface 410 (e.g., data conduit, information throughput avenue, application programming interface (API), application binary interface (ABI), communication capability, input interface, output interface, expression of available parameters, negotiation protocol, mechanism to coordinate exchange of data, or a combination thereof, etc.) to determine (e.g., ascertain, establish, specify, identify, decide, or a combination thereof, etc.) one or more conditions 1072 (e.g., circumstance, relevant antecedent, situation, factor, possible prerequisite, characteristic, ingredient, or a combination thereof, etc.) that are pertinent to (e.g., relevant to, impacting, affecting, applicable to, or a combination thereof, etc.) implementation (e.g., realization, effectuation, activation, operation, exploitation, administration, utilization, or a combination thereof, etc.) of an antenna assembly configuration parameter framework 414 (e.g., foundation, schema, structure, frame, shell, or a combination thereof, etc. that pertains to a cloud-based, cloud-enabled, database-including (e.g., a storage solution that provides responses to queries, such as an structured query language (SQL) database), server-employing, or a combination thereof, etc. implementation or usage of antenna assembly configuration parameters that promotes their manipulation, dissemination, organization, storage, application, handling, administration, or a combination thereof, etc.).

For example, an operation 6090 may include an operation 6092 of presenting at least one interface to identify one or more conditions that may be included in an antenna configuration data structure. For instance, at least one portable wireless node (e.g., a portable wireless node 1002P, such as an Apple iPhone) may present (e.g., offer) at least one interface 410 (e.g., data communication pathway) to identify (e.g., recognize, categorize, list, establish, ascertain, enumerate, specify, or a combination thereof, etc.) one or more conditions 1072 (e.g., circumstance) that may be included in an antenna configuration data structure 1008 (e.g., a database of conditions 1072 and antenna assembly configuration parameters 1070 (e.g., of FIG. 1E)).

For example, an operation 6090 may include an operation 6094 of presenting at least one interface to determine at least one condition relating to one or more bandwidth constraints. For instance, at least one portable wireless node (e.g., a portable wireless node 1002P, such as a Samsung Galaxy smart phone) may present (e.g., make available) at least one interface 410 (e.g., application programming interface (API)) to determine (e.g., ascertain) at least one condition 1072 (e.g., situation) relating to (e.g., pertaining to, corresponding to, interrelated with, or a combination thereof, etc.) one or more bandwidth constraints 486 (e.g., data speed—such as bits per second—requested, type of data—such as gaming versus email versus streaming, total data size to be transferred, minimum acceptable bandwidth, maximum anticipated bandwidth, importance of data—such as if first responders are to be given priority, or a combination thereof, etc.).

For example, an operation 6090 may include an operation 6096 of presenting at least one interface to determine at least one condition relating to one or more power constraints. For instance, at least one portable wireless node (e.g., a portable wireless node 1002P, such as an HTC smart phone) may present (e.g., produce) at least one interface 410 (e.g., protocol) to determine (e.g., decide) at least one condition 1072 (e.g., possible prerequisite) relating to (e.g., pertaining to, corresponding to, interrelated with, or a combination thereof, etc.) one or more power constraints 488 (e.g., remaining battery life, acceptable power expenditure for transmission or reception or wireless communication, acceptable power expenditure to communicate with a particular counterpart wireless node, acceptable power expenditure depending on task or application engaging a wireless communication, battery power versus being plugged in, or a combination thereof, etc.).

For example, an operation 6090 may include an operation 6098 of presenting at least one interface to determine at least one condition relating to one or more historical patterns. For instance, at least one portable wireless node (e.g., a portable wireless node 1002P, such as an Android tablet) may present (e.g., expose) at least one interface 410 (e.g., an operating system (OS) capability) to determine (e.g., establish) at least one condition 1072 (e.g., relevant antecedent) relating to (e.g., pertaining to, corresponding to, interrelated with, or a combination thereof, etc.) one or more historical patterns 490 (e.g., repeated action, daily activity, weekly habit, recurring usage, a walk to a vehicle after work precedes being plugged in with respect to power concerns, a walk down a hallway at an office building leads to a particular office with respect to path or directionality, regular location, or a combination thereof, etc.).

For example, an operation 6090 may include an operation 6100 of presenting at least one interface to determine at least one condition relating to one or more co-existing tasks. For instance, at least one portable wireless node (e.g., a portable wireless node 1002P, such as a Kindle Fire tablet or phone) may present (e.g., interact with) at least one interface 410 (e.g., expression of available or relevant parameters) to determine (e.g., stipulate) at least one condition 1072 (e.g., characteristic) relating to (e.g., pertaining to, corresponding to, interrelated with, or a combination thereof, etc.) one or more co-existing tasks 492 (e.g., contemporaneously performed activities, linked actions, interrelated applications, dependent tasks occurring at different times, other bandwidth-consuming activities in progress, voice call plus text messaging, an entry indicating media-streaming-capable bandwidth, or a combination thereof, etc.).

For example, an operation 6090 may include an operation 6102 of presenting at least one interface to determine at least one condition relating to one or more temporal circumstances. For instance, at least one portable wireless node (e.g., a portable wireless node 1002P, such as a UAV) may present (e.g., create) at least one interface 410 (e.g., parameter-capable input or output function call) to determine (e.g., agree on) at least one condition 1072 (e.g., factor) relating to (e.g., pertaining to, corresponding to, interrelated with, or a combination thereof, etc.) one or more temporal circumstances 494 (e.g., time of day, day of week, work time, personal time, family time, scheduled event, week day versus weekend day, or a combination thereof, etc.).

For example, an operation 504 may include an operation 6104 of transmitting the one or more antenna assembly configuration parameters to the at least one remote node. For instance, at least one portable wireless node (e.g., a portable wireless node 1002P, such as an Apple iPad) may transmit (e.g., send, communicate wirelessly, frequency up-convert, modulate, encode, propagate, emanate from an emitter or antenna or network port, or a combination thereof, etc.) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, one or more phase delays, meta-material antenna control signal values, phased-array antenna operational inputs, antenna element or junction selection indicators, or a combination thereof, etc.) to at least one remote node 412 (e.g., a telecommunications node 1014, an internet node 1016, a gateway, a server, a device providing cloud-computing services, or a combination thereof, etc.).

For example, an operation 504 may include an operation 6106 of receiving the one or more antenna assembly configuration parameters from the at least one remote node. For instance, at least one portable wireless node (e.g., a portable wireless node 1002P, such as an Apple iWatch) may receive (e.g., accept, decode, demodulate, down-convert, detect, obtain from or via a communication or transmission from another, route from an antenna or antenna element, take into possession wirelessly, or a combination thereof, etc.) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, one or more phase delays, meta-material antenna control signal values, phased-array antenna operational inputs, antenna element or junction selection indicators, or a combination thereof, etc.) to at least one remote node 412 (e.g., a telecommunications node 1014, an internet node 1016, a gateway, a server, a device providing cloud-computing services, or a combination thereof, etc.).

For example, an operation 504 may include an operation 6108 of downloading the one or more antenna assembly configuration parameters based at least partly on at least one query provided to the at least one remote node. For instance, at least one portable wireless node (e.g., a portable wireless node 1002P, such as a Lenovo laptop) may download (e.g., receive from cloud service or telecommunications service provider or retrieve from a remote internet server) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, one or more phase delays, meta-material antenna control signal values, phased-array antenna operational inputs, antenna element or junction selection indicators, or a combination thereof, etc.) based at least partly on at least one query 496 (e.g., request, listing of variables, specification of at least one factor, inquiry with relevant environmental attributes—such as parameters for 5^{th} floor Deckard Building for an Apple iPhone 6, an input to a database, or a combination thereof, etc.) provided (e.g., sent, submitted, made available, posted, entered, or a combination thereof, etc.) to at least one remote node 412 (e.g., a telecommunications node 1014, an internet node 1016, a gateway, a server, a device providing cloud-computing services, or a combination thereof, etc.).

Those skilled in the art will appreciate that the foregoing specific exemplary processes and/or machines and/or technologies are representative of more general processes and/or machines and/or technologies taught elsewhere herein, such as in the claims filed herewith and/or elsewhere in the present application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Modules, logic, circuitry, hardware and software combinations, firmware, or so forth may be realized or implemented as one or more general-purpose processors, one or more processing cores, one or more special-purpose processors, one or more microprocessors, at least one Application-Specific Integrated Circuit (ASIC), at least one Field Programmable Gate Array (FPGA), at least one digital signal processor (DSP), some combination thereof, or so forth that is executing or is configured to execute instructions, a special-purpose program, an application, software, code, some combination thereof, or so forth as at least one special-purpose computing apparatus or specific computing component. One or more modules, logic, or circuitry, etc. may, by way of example but not limitation, be implemented using one processor or multiple processors that are configured to execute instructions (e.g., sequentially, in parallel, at least partially overlapping in a time-multiplexed fashion, at least partially overlapping across multiple cores, or a combination thereof, etc.) to perform a method or realize a particular computing machine. For example, a first module may be embodied by a given processor executing a first set of instructions at or during a first time, and a second module may be embodied by the same given processor executing a second set of instructions at or during a second time. Moreover, the first and second times may be at least partially interleaved or overlapping, such as in a multi-threading, pipelined, or predictive processing environment. As an alternative example, a first module may be embodied by a first processor executing a first set of instructions, and a second module may be embodied by a second processor executing a second set of instructions. As another alternative example, a particular module may be embodied partially by a first processor executing at least a portion of a particular set of instructions and embodied partially by a second processor executing at least a portion of the particular set of instructions. Other combinations of instructions, a program, an application, software, or code, etc. in conjunction with at least one processor or other execution machinery may be utilized to realize one or more modules, logic, or circuitry, etc. to implement any of the processing algorithms described herein.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

This application may make reference to one or more trademarks, e.g., a word, letter, symbol, or device adopted by one manufacturer or merchant and used to identify and distinguish his or her product from those of others. Trademark names used herein are set forth in such language that makes clear their identity, that distinguishes them from common descriptive nouns, that have fixed and definite meanings, and, in many if not all cases, are accompanied by other specific identification using terms not covered by trademark. In addition, trademark names used herein have meanings that are well-known and defined in the literature, and do not refer to products or compounds protected by trade secrets in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or [trade], even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for supporting antenna assembly configuration network infrastructure, the method being at least partially implemented by at least one device, the method comprising:
presenting at least one interface to facilitate implementation of an antenna assembly configuration parameter framework; and
communicating with at least one remote node to share one or more antenna assembly configuration parameters that are associated with at least one orientation position of at least one portable wireless node.

2. The method of claim 1, wherein the presenting at least one interface to facilitate implementation of an antenna assembly configuration parameter framework comprises:
registering with the at least one remote node with respect to the antenna assembly configuration parameter framework.

3. The method of claim 2, wherein the registering with the at least one remote node with respect to the antenna assembly configuration parameter framework comprises:
registering with the at least one remote node with respect to the antenna assembly configuration parameter framework using at least one application executing on a portable wireless node.

4. The method of claim 2, wherein the registering with the at least one remote node with respect to the antenna assembly configuration parameter framework comprises:
registering with the at least one remote node with respect to the antenna assembly configuration parameter framework using at least one operating system of a portable wireless node.

5. The method of claim 2, wherein the registering with the at least one remote node with respect to the antenna assembly configuration parameter framework comprises:
providing to the at least one remote node at least one indication of device information for a portable wireless node.

6. The method of claim 5, wherein the providing to the at least one remote node at least one indication of device information for a portable wireless node comprises:
providing at least one indication of a type of the portable wireless node.

7. The method of claim 5, wherein the providing to the at least one remote node at least one indication of device information for a portable wireless node comprises:
providing at least one indication of a model of the portable wireless node.

8. (canceled)

9. The method of claim 1, wherein the presenting at least one interface to facilitate implementation of an antenna assembly configuration parameter framework comprises:
receiving from the at least one remote node at least one request to participate in the antenna assembly configuration parameter framework.

10. The method of claim 1, wherein the presenting at least one interface to facilitate implementation of an antenna assembly configuration parameter framework comprises:
formulating at least one message to notify the at least one remote node of an intent to participate in the antenna assembly configuration parameter framework.

11. The method of claim 1, wherein the presenting at least one interface to facilitate implementation of an antenna assembly configuration parameter framework comprises:
processing at least one inquiry asking if at least one user preference has been selected with respect to the antenna assembly configuration parameter framework.

12. The method of claim 1, wherein the presenting at least one interface to facilitate implementation of an antenna assembly configuration parameter framework comprises:
transmitting to the at least one remote node at least one indication of at least one user preference with respect to the antenna assembly configuration parameter framework.

13. The method of claim 12, wherein the transmitting to the at least one remote node at least one indication of at least one user preference with respect to the antenna assembly configuration parameter framework comprises:
signaling at least one bandwidth consumption preference.

14. The method of claim 12, wherein the transmitting to the at least one remote node at least one indication of at least one user preference with respect to the antenna assembly configuration parameter framework comprises:
signaling at least one cache size preference.

15. The method of claim 12, wherein the transmitting to the at least one remote node at least one indication of at least one user preference with respect to the antenna assembly configuration parameter framework comprises:
signaling at least one battery-related preference.

16-21. (canceled)

22. The method of claim 1, wherein the communicating with at least one remote node to share one or more antenna assembly configuration parameters that are associated with at least one orientation position of at least one portable wireless node comprises:
sharing one or more indications of how to configure at least one antenna assembly to form a beam in at least one particular direction with the one or more indications associated with the at least one orientation position of the at least one portable wireless node.

23. The method of claim 1, wherein the communicating with at least one remote node to share one or more antenna assembly configuration parameters that are associated with at least one orientation position of at least one portable wireless node comprises:
sharing one or more antenna assembly configuration parameters that are associated with the at least one orientation position of the at least one portable wireless node and that are applicable to at least one meta-material antenna.

24. The method of claim 1, wherein the communicating with at least one remote node to share one or more antenna assembly configuration parameters that are associated with at least one orientation position of at least one portable wireless node comprises:
sharing one or more antenna assembly configuration parameters that are associated with the at least one orientation position of the at least one portable wireless node and that are applicable to at least one array-based antenna.

25. The method of claim 24, wherein the sharing one or more antenna assembly configuration parameters that are associated with the at least one orientation position of the at least one portable wireless node and that are applicable to at least one array-based antenna comprises:
uni-directionally sharing the one or more antenna assembly configuration parameters with the at least one remote node.

26. The method of claim 1, wherein the presenting at least one interface to facilitate implementation of an antenna assembly configuration parameter framework comprises:
presenting at least one interface to negotiate at least one control factor with respect to the antenna assembly configuration parameter framework.

27. The method of claim 26, wherein the presenting at least one interface to negotiate at least one control factor with respect to the antenna assembly configuration parameter framework comprises:
negotiating at least one granularity with regard to at least one antenna configuration data structure.

28. The method of claim 27, wherein the negotiating at least one granularity with regard to at least one antenna configuration data structure comprises:
negotiating at least one granularity for one or more spatial location entries of the at least one antenna configuration data structure.

29. The method of claim 27, wherein the negotiating at least one granularity with regard to at least one antenna configuration data structure comprises:
negotiating at least one granularity for one or more orientation position entries of the at least one antenna configuration data structure.

30. The method of claim 26, wherein the presenting at least one interface to negotiate at least one control factor with respect to the antenna assembly configuration parameter framework comprises:
negotiating at least one update schedule with regard to at least one antenna configuration data structure.

31. The method of claim 30, wherein the negotiating at least one update schedule with regard to at least one antenna configuration data structure comprises:
negotiating at least one temporal delta threshold with regard to the at least one antenna configuration data structure.

32. The method of claim 30, wherein the negotiating at least one update schedule with regard to at least one antenna configuration data structure comprises:
negotiating at least one physical state delta threshold with regard to the at least one antenna configuration data structure.

33. The method of claim 32, wherein the negotiating at least one physical state delta threshold with regard to the at least one antenna configuration data structure comprises:
negotiating at least one spatial location delta threshold with regard to the at least one antenna configuration data structure.

34. (canceled)

35. The method of claim 1, wherein the presenting at least one interface to facilitate implementation of an antenna assembly configuration parameter framework comprises:
presenting at least one interface to negotiate if a signal bank shot factor is to be considered to use at least one antenna configuration data structure.

36. The method of claim 1, wherein the presenting at least one interface to facilitate implementation of an antenna assembly configuration parameter framework comprises:
presenting at least one interface to negotiate if a power level factor is to be considered to use at least one antenna configuration data structure.

37. The method of claim 1, wherein the presenting at least one interface to facilitate implementation of an antenna assembly configuration parameter framework comprises:
presenting at least one interface to negotiate if at least a portion of at least one antenna configuration data structure is to be downloaded on-demand or prospectively.

38. The method of claim 1, wherein the presenting at least one interface to facilitate implementation of an antenna assembly configuration parameter framework comprises:
presenting at least one interface to negotiate if at least a portion of at least one antenna configuration data structure is to be downloaded responsive to a navigational path to a destination.

39. The method of claim 1, wherein the presenting at least one interface to facilitate implementation of an antenna assembly configuration parameter framework comprises:
presenting at least one interface to determine one or more conditions that are pertinent to implementation of the antenna assembly configuration parameter framework.

40. The method of claim 39, wherein the presenting at least one interface to determine one or more conditions that are pertinent to implementation of the antenna assembly configuration parameter framework comprises:
presenting at least one interface to identify one or more conditions that may be included in an antenna configuration data structure.

41. The method of claim 39, wherein the presenting at least one interface to determine one or more conditions that are pertinent to implementation of the antenna assembly configuration parameter framework comprises:
presenting at least one interface to determine at least one condition relating to one or more bandwidth constraints.

42. The method of claim 39, wherein the presenting at least one interface to determine one or more conditions that are pertinent to implementation of the antenna assembly configuration parameter framework comprises:
presenting at least one interface to determine at least one condition relating to one or more power constraints.

43. The method of claim 39, wherein the presenting at least one interface to determine one or more conditions that are pertinent to implementation of the antenna assembly configuration parameter framework comprises:
presenting at least one interface to determine at least one condition relating to one or more historical patterns.

44. The method of claim 39, wherein the presenting at least one interface to determine one or more conditions that are pertinent to implementation of the antenna assembly configuration parameter framework comprises:
presenting at least one interface to determine at least one condition relating to one or more co-existing tasks.

45. The method of claim 39, wherein the presenting at least one interface to determine one or more conditions that are pertinent to implementation of the antenna assembly configuration parameter framework comprises:
presenting at least one interface to determine at least one condition relating to one or more temporal circumstances.

46. The method of claim 1, wherein the communicating with at least one remote node to share one or more antenna assembly configuration parameters that are associated with at least one orientation position of at least one portable wireless node comprises:
transmitting the one or more antenna assembly configuration parameters to the at least one remote node.

47. The method of claim 1, wherein the communicating with at least one remote node to share one or more antenna assembly configuration parameters that are associated with at least one orientation position of at least one portable wireless node comprises:
receiving the one or more antenna assembly configuration parameters from the at least one remote node.

48. The method of claim 1, wherein the communicating with at least one remote node to share one or more antenna assembly configuration parameters that are associated with at least one orientation position of at least one portable wireless node comprises:
downloading the one or more antenna assembly configuration parameters based at least partly on at least one query provided to the at least one remote node.

49. A device for supporting antenna assembly configuration network infrastructure, the device comprising:
circuitry for presenting at least one interface to facilitate implementation of an antenna assembly configuration parameter framework; and
circuitry for communicating with at least one remote node to share one or more antenna assembly configuration parameters that are associated with at least one orientation position of at least one portable wireless node.

50-96. (canceled)

97. An apparatus for supporting antenna assembly configuration network infrastructure, the apparatus comprising:
means for presenting at least one interface to facilitate implementation of an antenna assembly configuration parameter framework; and
means for communicating with at least one remote node to share one or more antenna assembly configuration parameters that are associated with at least one orientation position of at least one portable wireless node.

98-144. (canceled)
